(19) United States
(12) Patent Application Publication
(10) Pub. No.: US 2026/0338179 A1
(43) Pub. Date: Oct. 29, 2026

(54) APPARATUS FOR AND METHOD OF CONTROLLING PUMP OPERATION

(71) Applicant: Quick Quack Car Wash Holdings, LLC, Roseville, CA (US)

(72) Inventor: Rodney Daniel Sparks, Roseville, CA (US)

(73) Assignee: Quick Quack Car Wash Holdings, LLC, Roseville, CA (US)

(21) Appl. No.: 19/658,504

(22) Filed: Apr. 25, 2026

Related U.S. Application Data
(60) Provisional application No. 63/794,590, filed on Apr. 25, 2025.

(51) Int. Cl. F04B 49/20; F04B 43/12; F04B 49/06

(52) U.S. Cl. CPC F04B 49/20; F04B 43/12; F04B 49/065; F04B 2203/0209; F04B 2205/09

(57) ABSTRACT

An apparatus and method for controlling pump operation. The apparatus includes at least a processor configured to receive pump operational data comprising a motor speed associated with a pump, wherein the pump is fluidly connected to at least a fluid storage container containing a fluid, determine a predicted fluid flow of the fluid rate based on the motor speed, determine an actual fluid consumption of the fluid based on the fluid level measurement from the at least a fluid storage container, compare the predicted fluid flow rate with the actual fluid consumption to determine a discrepancy value, generate a trim coefficient based on the discrepancy value, adjust the motor speed of the pump based on the trim coefficient to compensate for a change in volumetric pump efficiency; and generate an output comprising a calibrated pump control signal configured to maintain a target fluid delivery volume.

### CROSS-REFERENCE TO RELATED APPLICATIONS

This application claims priority to Provisional Application No. 63/794,590 filed on Apr. 25, 2025, and entitled “SYSTEMS AND METHODS FOR DISPENSING SYSTEMS,” the entirety of both of which are incorporated herein by reference.

### FIELD OF THE INVENTION

The present invention generally relates to the field of fluid pumping systems. In particular, the present invention is directed to an apparatus for and a method of controlling pump operation.

### BACKGROUND

Pumps are commonly used to deliver controlled volumes of fluids in applications such as chemical dosing, water treatment, and industrial processing systems. In such pumps, fluid is transported through flexible tubing that is repeatedly compressed by rotating pump elements during operation. Over time, the repeated mechanical compression and relaxation of the tubing may cause material fatigue, deformation, or wear of the tubing. As the pump tubing degrades, the volumetric output of the pump may deviate from an expected flow rate associated with a given motor speed, which can result in inaccurate fluid delivery and inconsistent dosing performance. Conventional systems often rely on periodic manual calibration or technician intervention to address these deviations, which may increase maintenance requirements and allow dosing inaccuracies to persist between calibration events.

### SUMMARY OF THE DISCLOSURE

In an aspect, an apparatus for controlling pump operation includes at least a processor and a memory communicatively connected to the at least a processor. The memory contains instructions configuring the processor to receive pump operational data comprising a motor speed associated with a pump, wherein the pump is fluidly connected to at least a fluid storage container containing a fluid, determine a predicted fluid flow rate of the fluid based on the motor speed, determine an actual fluid consumption of the fluid based on at least a measurement indicative of a fluid flow of the fluid from the fluid storage container, compare the predicted fluid flow rate with the actual fluid consumption to determine a discrepancy value, generate a trim coefficient based on the discrepancy value, adjust the motor speed of the pump based on the trim coefficient to compensate for a change in volumetric pump efficiency, and generate an output including a calibrated pump control signal as a function of the adjusted motor speed, wherein the calibrated pump control signal is configured to maintain a target fluid delivery volume.

In another aspect, a method of controlling pump operation includes receiving, using at least a processor communicatively connected to a pump, pump operational data including a motor speed associated with the pump, wherein the pump is fluidly connected to at least a fluid storage container, determining, using the at least a processor, a predicted fluid flow rate of the fluid based on the motor speed, determining, using the at least a processor, an actual fluid consumption of the fluid based on at least a measurement indicative of a fluid flow from the fluid storage container, comparing, using the at least a processor, the predicted fluid flow rate with the actual fluid consumption to determine a discrepancy value, generating, using the at least a processor, a trim coefficient based on the discrepancy value, adjusting, using the at least a processor, the motor speed of the pump based on the trim coefficient to compensate for a change in volumetric pump efficiency, and generating, using the at least a processor, an output comprising a calibrated pump control signal as a function of the adjusted motor speed, wherein the calibrated pump control signal is configured to maintain a target fluid delivery volume.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for controlling pump operation;

FIG. 2 is an exemplary illustration of an exemplary embodiment of a graphical user interface;

FIG. 3 is a block diagram of an exemplary embodiment of a machine-learning module;

FIG. 4 is a diagram of an exemplary embodiment of a neural network;

FIG. 5 is a diagram of an exemplary embodiment of a node of a neural network;

FIG. 6 is a block diagram of an exemplary embodiment of a method of controlling pump operation; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for controlling pump operation. The apparatus includes at least a computing device comprised of a processor and a memory communicatively connected to the processor. The memory instructs the processor to receive pump operational data comprising a motor speed associated with a pump and a fluid level measurement from at least a fluid storage container. The processor determines a predicted fluid flow rate based on the motor speed. The processor determines an actual fluid consumption based on the fluid level measurement from the fluid storage container. Additionally, the processor compares the predicted fluid flow with the actual fluid consumption to determine a discrepancy value. The processor generates a trim coefficient based on the discrepancy value. The memory then instructs the processor to adjusts the motor speed of the pump based on the trim coefficient to compensate for degradation of peristaltic pump tubing. The processor generates an output comprising a calibrated pump control signal as a function of the adjusted motor speed, wherein the calibrated pump control signal is configured to maintain a target fluid delivery volume

Exemplary embodiments illustrating aspects of the present disclosure are described below in the context of several specific examples.

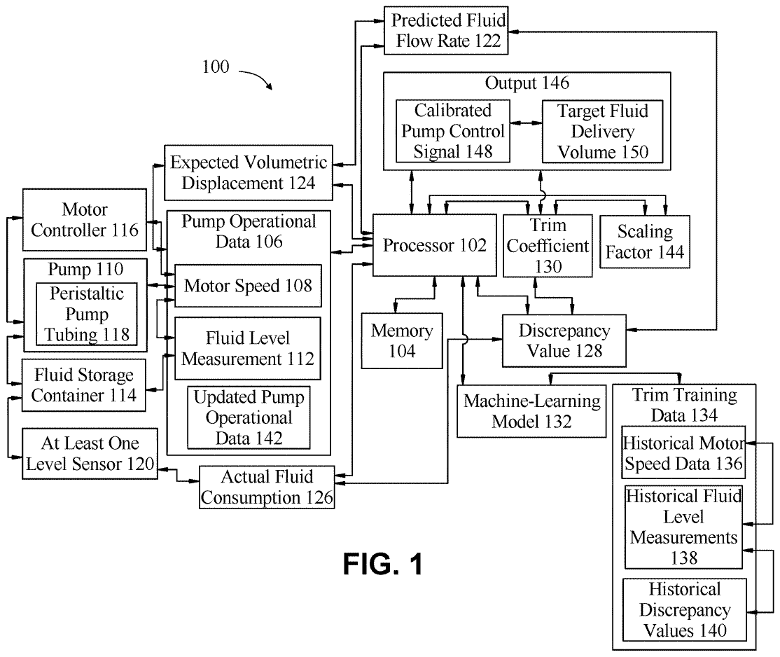

Referring now to FIG. 1, the apparatus 100 includes an adaptive pump trim calibration algorithm configured as a control methodology designed to compensate for physical degradation of peristaltic pump tubing over time. The apparatus 100 is configured to continuously compare a predicted chemical flow, determined based on a motor RPM of a pump, with an actual chemical consumption measured using one or more tank level sensors. When a discrepancy between the predicted chemical flow and the actual chemical consumption is detected due to wear of the peristaltic pump tubing, the adaptive pump trim calibration algorithm automatically updates a trim coefficient to increase the motor speed of the pump. Updating the trim coefficient in this manner ensures that a delivered chemical volume remains accurate despite degradation of the peristaltic pump tubing, while reducing or eliminating a need for manual recalibration by a technician.

With continued reference to FIG. 1, an exemplary embodiment of apparatus 100 for controlling pump operation is illustrated. Apparatus 100 may include a processor 102 communicatively connected to a memory 104. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 104 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor 102 may access the information from primary memory.

Still referring to FIG. 1, apparatus 100 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, apparatus 100 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the apparatus computing device. In one or more embodiments, computing device may transmit processes to server wherein computing device may conserve power or energy.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting processor 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 102 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 102 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 102 is configured to receive pump operational data 106 comprising a motor speed 108 associated with a pump 110 and a fluid level measurement 112 from at least a fluid storage container 114. As used in this disclosure, “pump operational data” is data representing one or more parameters associated with operation, performance, or status of a pump 110 during fluid transfer. In an embodiment, pump operational data 106 may include information indicating pump speed, pump runtime, or commanded operating conditions received from a motor controller 116. In a non-limiting example, pump operational data 106 may include measurements obtained from sensors associated with a pumping system, including measurements indicating fluid levels, pressures, or flow conditions. Without limitation, pump operational data 106 may be collected by one or more processors from controllers, sensors, or monitoring systems and processed to determine operational characteristics of the pump 110.

With continued reference to FIG. 1, as used in this disclosure, “motor speed” is a parameter representing a rate of rotation of a motor configured to drive a pump 110. In an embodiment, motor speed 108 may correspond to a rotational rate of a motor shaft used to actuate pumping elements of a peristaltic pump. In a non-limiting example, motor speed 108 may be represented as revolutions per minute or another rotational measurement provided by a motor controller 116 or encoder. For example, without limitation, motor speed 108 may be determined using feedback signals generated by a motor driver, a rotational encoder, or a digital motor control module. As used in this disclosure, “fluid level” is a representation of a quantity or height of fluid present within a container. In an embodiment, fluid level may correspond to a measurement obtained from a level sensing device configured to detect an amount of liquid contained in a storage vessel. In a non-limiting example, fluid level may be determined using sensor systems configured to measure changes in fluid height or volume within the container during pump operation. Without limitation, fluid level measurements 112 may be obtained through sensing technologies integrated with a monitoring system configured to provide fluid inventory or consumption information. In an embodiment, the sensing technologies may comprise ultrasonic level sensors, pressure-based level sensors, optical level sensors, capacitive level sensors, float-based sensors, radar sensors, or weight-based measurement devices configured to detect a quantity of fluid contained within a fluid storage container 114. In a non-limiting example, the sensing technologies may be communicatively connected to a controller, programmable logic controller, embedded computing device, or cloud-connected monitoring platform configured to collect and process fluid level measurements 112. For example, without limitation, the sensing technologies may include sensors mounted within or adjacent to a fluid storage container 114 and configured to periodically transmit fluid level measurements 112 to a processor 102 through wired communication interfaces or wireless communication networks. In another embodiment, the monitoring system may comprise software systems configured to aggregate fluid level measurements 112 from multiple containers, analyze fluid consumption trends, and generate alerts indicating low chemical levels or abnormal consumption rates. Without limitation, integrating the sensing technologies with automated monitoring systems may improve operational efficiency by enabling real-time tracking of chemical inventory and facilitating more accurate control of fluid delivery during operation of the pump system. In some implementations, the fluid may comprise one or more treatment or process chemicals stored within the container for controlled delivery by a pump 110. In a non-limiting example, the fluid may comprise water treatment chemicals such as chlorine, sodium hypochlorite, or ferric chloride used in dosing systems. For example, without limitation, the fluid may comprise industrial or processing chemicals including acids, bases, disinfectants, coagulants, or other liquid reagents configured to be dispensed in controlled quantities. In some implementations, the fluid may comprise one or more chemicals used in vehicle washing systems. In an embodiment, the fluid may comprise cleaning chemicals including detergents, foaming soaps, pre-soak solutions, or surfactant-based cleaning agents configured to remove dirt, oil, or debris from vehicle surfaces. In a non-limiting example, the fluid may comprise treatment chemicals including wax solutions, sealants, drying agents, or protectant coatings dispensed during automated vehicle wash cycles. For example, without limitation, the fluid may comprise wheel cleaners, tire cleaners, bug removal solutions, or specialty pre-treatment chemicals configured to break down road contaminants. In another embodiment, the fluid may comprise spot-free rinse solutions, reverse osmosis treated rinse additives, or water conditioning chemicals used to reduce mineral spotting on vehicle surfaces. Without limitation, the fluid may comprise fragrance solutions, colored foam chemicals, ceramic coating solutions, or polishing agents configured to enhance vehicle appearance during automated wash processes. In some embodiments, apparatus 100 may be implemented as a component of a larger vehicle washing system configured to perform automated cleaning, treatment, and finishing operations on vehicles. For example, and without limitation, apparatus 100 may be integrated within a chemical dosing subsystem of an automated car wash installation, wherein the apparatus 100 regulates delivery of cleaning agents such as detergents, pre-soak solutions, waxes, sealants, drying agents, or specialty treatment chemicals used throughout a wash cycle. In such embodiments, apparatus 100 may communicate with other system components including conveyor controllers, spray arches, foam applicators, and rinse modules to coordinate precise chemical application based on vehicle position, wash stage, or operational parameters. The adaptive calibration functionality described herein may enable the vehicle washing system to maintain consistent chemical dosing performance despite wear of peristaltic pump tubing or variations in fluid properties, thereby improving wash quality and reducing chemical waste. In other embodiments, apparatus 100 may be deployed within additional fluid delivery installations including water treatment systems, industrial processing lines, agricultural irrigation or fertigation systems, food and beverage processing facilities, or sanitation and disinfection systems, wherein accurate and reliable fluid dosing is required under changing operating conditions.

With continued reference to FIG. 1, as used in this disclosure, “fluid storage container” is a structure configured to contain and store a fluid for transfer by a pump. In an embodiment, the fluid storage container 114 may comprise a tank, reservoir, or vessel configured to hold a chemical, reagent, or treatment fluid. In a non-limiting example, the fluid storage container 114 may be positioned upstream of a pump 110 so that fluid may be withdrawn from the container during a pumping operation. For example, without limitation, the fluid storage container 114 may be integrated with sensing systems configured to measure a fluid level within the container for monitoring or control purposes. In one or more embodiments, pump may be fluidly connected to fluid storage container such that there is a physical channel, such as a pipe, hose, or manifold, linking the reservoir to the pump's inlet (suction) or outlet (discharge).

With continued reference to FIG. 1, pump 110 is fluidly connected to at least fluid storage container containing fluid. In one or more embodiments, pump is fluidly connected to at least a storage container such that fluid from within fluid container may be pumped through tubing, channels and/or the like using pump 110. In one or more embodiments, pump is fluidly connected to at least storage container, wherein fluid within fluid container may be manipulated by pump 110. In one or more embodiments, fluid within fluid storage container may travel through pump tubing such as peristaltic pump tubing connected to both pump and container.

With continued reference to FIG. 1, in an embodiment, the pump operational data 106 may be received through a wired communication interface communicatively coupled to a motor controller 116 associated with the pump 110, wherein the motor controller 116 may transmit motor speed 108 data generated by a motor encoder, tachometer, drive controller, or other rotational sensing device capable of indicating pump motor revolutions per minute. In a non-limiting example, the processor 102 may receive the motor speed 108 through industrial communication protocols transmitted over a network interface, wherein the network interface may support communication standards including Modbus communication protocols, Controller Area Network communication, Ethernet based industrial communication, serial communication interfaces, wireless telemetry modules, and the like. In an embodiment, the fluid level measurement associated with the fluid storage container 114 may be received from one or more level sensing devices positioned within or coupled to the fluid storage container 114. Without limitation, the level sensing device may comprise an ultrasonic level sensor configured to emit acoustic signals toward a surface of the stored fluid and determine a fluid level based on a reflected signal response, a pressure based hydrostatic sensor configured to determine fluid depth based on measured pressure, a capacitive level sensor configured to detect changes in capacitance corresponding to fluid presence, an optical level sensor configured to detect fluid boundaries using light transmission properties, a weight based load cell configured to measure a mass of the fluid storage container 114 and determine fluid quantity based on mass change, and the like. In an embodiment, the level sensing devices may transmit level measurement signals to processor 102 through analog signal lines, digital communication buses, wireless sensor networks, or remote telemetry systems. In another non limiting example, the pump operational data 106 may be received by processor 102 through a distributed monitoring system in which multiple sensors associated with the pump system transmit operational data to a centralized controller. The sensors may communicate through a gateway device configured to aggregate sensor data and transmit the aggregated data to processor 102 via a local network, an industrial control network, a cellular communication network, a satellite communication link, or a cloud based communication infrastructure. In such an embodiment, processor 102 may periodically poll connected devices for updated operational data or may receive the pump operational data 106 through event driven transmissions initiated by the motor controller 116, the level sensor 120, or an associated monitoring module. In an embodiment, the polling interval may occur at predetermined time increments such as every second, every several seconds, every minute, or other time durations selected to correspond with operational characteristics of the pump system and the expected rate of fluid consumption. Without limitation, the processor 102 may perform polling operations at higher frequencies during active pump operation in order to capture rapidly changing operational conditions, while lower frequency polling intervals may be used during idle periods or standby modes to reduce processing load and network traffic. In a non-limiting example, the processor 102 may initiate polling by transmitting a data request message to one or more connected devices including a motor controller 116, encoder interface module, level sensing device, gateway controller, supervisory control system, and the like. The connected devices may respond by transmitting current operational parameters including motor rotational speed, pump runtime metrics, tank level measurements, sensor health data, and the like. The received data may then be stored in memory 104 and processed by processor 102 to determine predicted flow values and measured consumption values used by the adaptive trim calibration process. In another embodiment, the processor 102 may receive pump operational data 106 through event driven transmissions generated by connected devices without requiring a polling request. For example, without limitation, a motor controller 116 associated with the pump 110 may automatically transmit a motor speed 108 update whenever a change in commanded motor speed 108 occurs, whenever the motor speed 108 deviates from a target value, or whenever a predefined reporting interval has elapsed. Similarly, a level sensing device associated with the fluid storage container 114 may transmit updated fluid level measurements 112 when the measured level changes by more than a threshold value, when a measurement sampling cycle occurs, when the pump 110 is activated, or when a supervisory monitoring system requests updated tank status information. In an embodiment, event driven data transmissions may be triggered by threshold crossing conditions, periodic reporting timers, operational state transitions, fault detection events, or scheduled telemetry intervals. Such transmissions may allow the processor 102 to receive operational data in near real time while reducing unnecessary communication traffic when system conditions remain stable. In this manner, processor 102 may maintain a continuously updated representation of pump operation and fluid consumption behavior that may be used to dynamically adjust trim coefficients and maintain accurate chemical delivery despite progressive degradation of pump tubing or other mechanical components.

With continued reference to FIG. 1, receiving the pump operational data 106 may further include receiving the motor speed 108 from a motor controller 116 communicatively connected to the pump 110, wherein the pump 110 comprises a peristaltic pump tubing 118. As used in this disclosure, “motor controller” is an electronic control device configured to regulate operation of a motor by controlling electrical power supplied to the motor in response to control signals or programmed instructions. In an embodiment, the motor controller 116 may receive a command signal from processor 102 and may regulate motor rotational speed of a pump 110 drive motor by adjusting voltage, current, pulse width modulation signals, frequency drive parameters, or other electrical control characteristics applied to the motor. In a non-limiting example, the motor controller 116 may comprise a variable frequency drive, a stepper motor driver, a brushless motor controller 116, a programmable logic controller output module, a digital motor driver circuit, and the like. Without limitation, the motor controller 116 may further generate operational feedback data including measured motor revolutions per minute, torque indicators, current consumption values, temperature measurements, fault status signals, and the like, which may be transmitted to processor 102 for use in pump operational monitoring and calibration processes. As used in this disclosure, “peristaltic pump tubing” is a flexible conduit positioned within a peristaltic pump and configured to transport fluid through the pump 110 in response to progressive compression of the conduit by rotating pump elements. In an embodiment, the peristaltic pump tubing 118 may be compressed by rotating rollers, shoes, cams, or other mechanical displacement elements that sequentially collapse and release portions of the tubing to generate a positive displacement pumping action that moves fluid through the conduit. In a non-limiting example, the peristaltic pump tubing 118 may be formed from elastomeric materials including silicone tubing, thermoplastic elastomers, fluoropolymer based tubing, reinforced polymer tubing, chemically resistant tubing materials, and the like. Without limitation, the peristaltic pump tubing 118 may experience mechanical wear during operation due to repeated compression cycles, chemical exposure, pressure fluctuations, temperature variation, and the like, which may gradually alter volumetric displacement characteristics of the pump 110 and may be compensated for using the adaptive calibration techniques described herein. The motor controller 116 may transmit motor speed 108 information measured using an encoder, tachometer, rotational sensor, internal drive monitoring circuit, or other rotational measurement component capable of determining motor revolutions per minute. The received motor speed 108 data may be used by processor 102 to determine a predicted fluid flow rate 122 value corresponding to an expected volumetric displacement 124 of the pump 110. In an embodiment, processor 102 may use the received motor speed 108 data together with fluid level measurements 112 obtained from the fluid storage container 114 to evaluate discrepancies between predicted pump output and measured chemical consumption, thereby enabling adaptive trim calibration that compensates for degradation of the peristaltic pump tubing 118 or other mechanical components within the pump system.

With continued reference to FIG. 1, receiving the pump operational data 106 may further include receiving the fluid level measurement from at least one level sensor 120 associated with the fluid storage container 114. As used in this disclosure, “level sensor” is a sensing device configured to measure the presence of a fluid. Without limitation, the fluid may be contained within a storage structure. Without limitation, the level sensor 120 may generate a signal representing the measured fluid level. In an embodiment, the level sensor 120 may determine the amount of fluid within a fluid storage container 114 by detecting a physical characteristic associated with the stored fluid such as distance to a fluid surface, hydrostatic pressure generated by a column of fluid, electrical capacitance changes associated with fluid presence, optical signal interruption, electromagnetic reflection, container mass variation, and the like. In a non-limiting example, the level sensor 120 may comprise an ultrasonic level sensor configured to measure distance to a fluid surface, a hydrostatic pressure sensor configured to measure pressure corresponding to fluid depth, a capacitive level probe configured to detect dielectric changes associated with fluid presence, an optical level detector configured to detect fluid boundaries using light transmission or reflection, a radar based level measurement device configured to determine surface distance using electromagnetic signals, a load cell configured to determine fluid quantity based on container weight, and the like. Without limitation, the level sensor 120 may generate an electrical signal, digital measurement value, or network transmitted data packet representing the detected fluid level that may be received and processed by a computing device. Receiving the pump operational data 106 further may include receiving the fluid level measurement from at least one level sensor 120 associated with the fluid storage container 114. In an embodiment, the level sensor 120 may be positioned within the fluid storage container 114, mounted above a fluid surface, coupled to an exterior wall of the container, integrated into a reservoir assembly, or otherwise positioned in a location capable of detecting the quantity of fluid stored within the container. The level sensor 120 may periodically measure the fluid level within the container and transmit measurement data to processor 102 through an electrical communication pathway including analog signal wiring, digital communication buses, industrial control networks, wireless communication modules, telemetry systems, and the like. In a non-limiting example, the level sensor 120 may generate repeated level measurements at defined sampling intervals so that processor 102 may track changes in the fluid quantity contained within the fluid storage container 114 over time. Processor 102 may store sequential fluid level measurements 112 in memory 104 and determine a rate of change in the fluid level based on differences between successive measurements. The calculated change in fluid level may correspond to an amount of chemical dispensed by the pump 110 during a measurement interval and may therefore represent an actual fluid consumption 126 value associated with pump operation. In another non-limiting example, multiple level sensors may be associated with the fluid storage container 114 or with multiple containers within a fluid delivery system. The sensors may transmit fluid level measurements 112 to processor 102 through a gateway device, supervisory control system, remote monitoring platform, distributed control network, or cloud based monitoring system. Processor 102 may aggregate the received level measurement data and correlate the measurements with pump operational data 106 including motor speed 108, pump runtime, dosing commands, and the like in order to determine discrepancies between predicted pump output and measured chemical consumption. In an embodiment, the level sensor 120 measurements may be continuously or periodically monitored while the pump 110 is operating so that processor 102 may maintain an updated representation of fluid inventory within the container. The updated level measurements may enable processor 102 to determine whether the pump 110 is delivering an expected volume of chemical based on commanded motor speed 108. When deviations are detected between predicted fluid flow rate 122 and measured fluid depletion from the container, processor 102 may generate or update trim calibration parameters that adjust pump motor speed 108 to compensate for performance changes caused by wear of peristaltic pump tubing 118 or other mechanical components within the pump system.

Still referring to FIG. 1, processor 102 is configured to determine a predicted fluid flow rate 122 based on the motor speed 108. As used in this disclosure, “predicted fluid flow rate” is a calculated value representing an expected volumetric quantity of fluid transferred or transported by a pump 110 during operation based on one or more pump operating parameters during a defined time interval. In an embodiment, predicted fluid flow rate 122 may be determined using a mathematical relationship between motor rotational speed and an expected volumetric displacement 124 associated with operation of the pump 110. The relationship may represent a correlation between a number of pump drive motor revolutions occurring during a given time interval and a corresponding quantity of fluid displaced by the pump 110 during those revolutions. Processor 102 may store one or more displacement coefficients representing an expected volume of fluid transferred during each rotation of a pump 110 rotor, and the processor 102 may multiply the measured motor speed 108 by the displacement coefficient to determine an estimated volumetric flow rate. In a non-limiting example, the pump 110 may be characterized such that each rotation of the pump 110 rotor displaces approximately two milliliters of chemical through the peristaltic pump tubing 118. If the motor controller 116 reports a motor speed 108 of 60 revolutions per minute, processor 102 may determine a predicted fluid flow rate 122 of approximately 120 milliliters per minute by multiplying 60 revolutions per minute by the displacement value of two milliliters per revolution. In another non-limiting example, the pump 110 may be configured such that each rotor revolution displaces approximately five milliliters of fluid due to a larger tubing diameter or a different rotor compression geometry. If processor 102 receives pump operational data 106 indicating that the motor is operating at 40 revolutions per minute, processor 102 may determine a predicted fluid flow rate 122 of approximately 200 milliliters per minute by multiplying 40 revolutions per minute by five milliliters per revolution. Continuing the previous non-limiting example, processor 102 may determine predicted fluid flow rate 122 over a time interval rather than as a rate. For example, without limitation, if the pump 110 operates at 40 revolutions per minute for 10 minutes and the displacement coefficient corresponds to five milliliters per revolution, processor 102 may determine that an expected total of approximately 2,000 milliliters of chemical should have been delivered during the 10 minute interval based on 400 total revolutions multiplied by five milliliters per revolution. In another non-limiting example, processor 102 may store a calibration curve representing expected pump output across multiple motor speed 108 ranges. The processor 102 may determine predicted fluid flow rate 122 by referencing the calibration curve using the detected motor speed 108. For example, without limitation, the calibration curve may indicate that operation at 30 revolutions per minute corresponds to approximately 90 milliliters per minute of fluid delivery, while operation at 70 revolutions per minute corresponds to approximately 210 milliliters per minute of fluid delivery. In an embodiment, the predicted fluid flow rate 122 values determined by processor 102 may be used as reference values when evaluating pump performance. Processor 102 may compare the predicted fluid flow rate 122 with an actual fluid consumption 126 value derived from tank level measurements obtained from the fluid storage container 114 in order to determine whether the pump 110 is delivering the expected quantity of chemical during operation. Deviations between the predicted fluid flow rate 122 and the measured fluid consumption may indicate mechanical degradation of peristaltic pump tubing 118 or other pump system components, which may trigger adaptive trim calibration adjustments that modify motor speed 108 to maintain accurate chemical dosing. In a non-limiting example, predicted fluid flow rate 122 may be calculated using calibration data that correlates motor revolutions per minute with an expected volume of chemical displaced by a peristaltic pump during each revolution of the pump 110 drive mechanism. Without limitation, predicted fluid flow rate 122 may be determined using pump characterization data, empirical calibration curves, manufacturer pump specifications, computational models, or other derived relationships capable of estimating fluid delivery based on pump operating conditions. In a non-limiting example, predicted fluid flow rate 122 may be determined using pump characterization data generated during installation or commissioning of the pump 110 system. For example, without limitation, a pump 110 characterization test may determine that operation at 20 revolutions per minute produces approximately 60 milliliters per minute of chemical delivery, operation at 40 revolutions per minute produces approximately 120 milliliters per minute, and operation at 80 revolutions per minute produces approximately 240 milliliters per minute. Processor 102 may store these characterization values in memory 104 and may determine predicted fluid flow rate 122 by referencing the stored relationship between motor speed 108 and expected pump output. In another non-limiting example, predicted fluid flow rate 122 may be determined using an empirical calibration curve derived from observed pump performance data. For instance, without limitation, calibration testing may indicate that operation at 25 revolutions per minute corresponds to approximately 75 milliliters per minute of delivered chemical, operation at 50 revolutions per minute corresponds to approximately 155 milliliters per minute due to tubing compression characteristics, and operation at 75 revolutions per minute corresponds to approximately 230 milliliters per minute. Processor 102 may apply the calibration curve to determine predicted fluid flow rate 122 based on the detected motor speed 108. In another non-limiting example, predicted fluid flow rate 122 may be determined using manufacturer pump specifications. For example, without limitation, manufacturer documentation may indicate that a particular peristaltic pump model delivers approximately 3 milliliters of fluid per rotor revolution when configured with tubing having an inner diameter of 6 millimeters. If processor 102 receives motor speed 108 data indicating that the motor is operating at 50 revolutions per minute, processor 102 may determine a predicted fluid flow rate 122 of approximately 150 milliliters per minute by multiplying 50 revolutions per minute by 3 milliliters per revolution. In another non-limiting example, predicted fluid flow rate 122 may be determined using a computational model stored in memory 104 that incorporates operating parameters affecting pump displacement. For instance, without limitation, the model may determine that a pump 110 operating at 60 revolutions per minute with tubing having an inner diameter of 4 millimeters and fluid viscosity of 10 centipoise produces approximately 140 milliliters per minute of chemical delivery, while the same pump operating at 60 revolutions per minute with fluid viscosity of 30 centipoise produces approximately 125 milliliters per minute due to increased flow resistance. Processor 102 may apply the computational model to the detected operating parameters to determine predicted fluid flow rate 122 under varying system conditions. In an embodiment, processor 102 may calculate predicted fluid flow rate 122 by applying a conversion relationship that correlates motor rotational speed with an expected volumetric displacement 124 of the pump 110 per unit time. For example, without limitation, a predetermined displacement value associated with each revolution of a pump 110 rotor may be multiplied by the measured motor revolutions per minute to determine an estimated volumetric flow rate of fluid delivered by the pump 110. In a non-limiting example, the conversion relationship used to determine predicted fluid flow rate 122 may be derived from pump calibration data obtained during manufacturing, installation, or commissioning of the pump 110 system. The calibration data may represent an expected volumetric displacement 124 per rotation of the pump 110 based on geometric characteristics of the pump 110 assembly, tubing diameter, tubing elasticity, rotor configuration, compression roller geometry, and the like. Processor 102 may store the calibration relationship in memory 104 and may apply the relationship to received motor speed 108 data to determine the predicted fluid flow rate 122 value during pump operation. In another non-limiting example, processor 102 may determine predicted fluid flow rate 122 using a computational model that incorporates multiple pump operating parameters including motor speed 108, pump runtime, pump duty cycle, tubing dimensions, chemical viscosity, pressure conditions, temperature conditions, and the like. The computational model may generate an estimated fluid delivery rate corresponding to the detected motor speed 108 and associated pump operating conditions. In an embodiment, the predicted fluid flow rate 122 may represent an expected quantity of chemical delivered by the pump 110 during a defined time interval and may be used as a reference value for evaluating pump performance. Processor 102 may compare the predicted fluid flow rate 122 with an actual fluid consumption 126 value derived from fluid level measurements 112 obtained from a fluid storage container 114. Differences between the predicted fluid flow rate 122 and the measured fluid consumption may indicate performance deviations associated with mechanical wear of peristaltic pump tubing 118 or other pump components, thereby enabling processor 102 to determine and update trim calibration parameters that maintain accurate chemical dosing.

With continued reference to FIG. 1, determining the predicted fluid flow rate 122 may include determining the predicted fluid flow rate 122 as a function of a relationship between motor revolutions per minute and an expected volumetric displacement 124 of the pump 110. As used in this disclosure, “relationship” is a defined correlation between two or more variables that expresses how a change in one variable corresponds to a change in another variable. In an embodiment, the relationship may represent a mathematical expression, lookup table, calibration curve, proportional coefficient, or computational model that associates a motor operating parameter with an expected pump output parameter. In a non-limiting example, the relationship may define how motor rotational speed corresponds to an estimated fluid delivery rate generated by operation of a pump 110. Without limitation, the relationship may be derived from pump characterization testing, empirical calibration data, manufacturer performance specifications, experimentally generated performance curves, or computational models representing pump operation. In an embodiment, the relationship associating a motor operating parameter with an expected pump output parameter may be implemented as a mathematical expression. The mathematical expression may represent a formula that converts a detected motor operating parameter such as motor revolutions per minute into an estimated volumetric flow value. In a non-limiting example, processor 102 may determine predicted fluid flow rate 122 using an equation in which predicted fluid flow rate 122 equals motor revolutions per minute multiplied by an expected volumetric displacement 124 value associated with each pump rotation. For instance, without limitation, if the expected volumetric displacement 124 corresponds to 3 milliliters per revolution and the motor speed 108 is detected at 50 revolutions per minute, processor 102 may determine a predicted fluid flow rate 122 of approximately 150 milliliters per minute using the stored mathematical expression. In an embodiment, the relationship may be implemented as a lookup table stored in memory 104. The lookup table may store predefined pump output values corresponding to specific motor operating parameters. Processor 102 may determine predicted fluid flow rate 122 by identifying the motor speed 108 value within the lookup table and retrieving a corresponding expected flow value. In a non-limiting example, the lookup table may indicate that 20 revolutions per minute corresponds to 60 milliliters per minute, 40 revolutions per minute corresponds to 120 milliliters per minute, and 80 revolutions per minute corresponds to 240 milliliters per minute. Processor 102 may reference the lookup table using the detected motor speed 108 to determine the predicted fluid flow rate 122 associated with pump operation. In another embodiment, the relationship may be represented as a calibration curve that reflects empirically measured pump performance across a range of operating conditions. The calibration curve may be generated by measuring actual fluid delivery at different motor speeds and storing the resulting data points within memory 104. Processor 102 may determine predicted fluid flow rate 122 by referencing the calibration curve using the detected motor revolutions per minute. In a non-limiting example, the calibration curve may indicate that operation at 30 revolutions per minute corresponds to approximately 90 milliliters per minute of fluid delivery, operation at 50 revolutions per minute corresponds to approximately 155 milliliters per minute due to tubing compression characteristics, and operation at 70 revolutions per minute corresponds to approximately 220 milliliters per minute. In an embodiment, the relationship may be implemented using a proportional coefficient that represents a scaling factor 144 correlating motor rotational speed with expected fluid displacement. The proportional coefficient may correspond to a constant multiplier representing an estimated volume of fluid displaced per revolution of the pump 110 rotor. Processor 102 may determine predicted fluid flow rate 122 by multiplying the measured motor revolutions per minute by the proportional coefficient. In a non-limiting example, if the proportional coefficient corresponds to 2.5 milliliters per revolution and the detected motor speed 108 is 60 revolutions per minute, processor 102 may determine that the predicted fluid flow rate 122 corresponds to approximately 150 milliliters per minute. In another embodiment, the relationship may be implemented as a computational model stored within memory 104 and executed by processor 102. The computational model may incorporate multiple pump operating parameters that influence fluid displacement, including motor revolutions per minute, tubing inner diameter, tubing elasticity characteristics, fluid viscosity, temperature conditions, pressure conditions within the fluid line, and the like. Processor 102 may process these operating parameters through the computational model to estimate an expected fluid delivery rate associated with pump operation. In a non-limiting example, the computational model may determine that a pump 110 operating at 60 revolutions per minute with tubing having an inner diameter of 4 millimeters and fluid viscosity of 10 centipoise produces approximately 140 milliliters per minute of chemical delivery, while the same pump operating at 60 revolutions per minute with fluid viscosity of 30 centipoise produces approximately 125 milliliters per minute due to increased flow resistance.

With continued reference to FIG. 1, as used in this disclosure, “motor revolutions per minute” is a representation of a quantity of rotational cycles performed by a motor shaft during a one minute time interval. In an embodiment, motor revolutions per minute may indicate a rotational speed at which a pump 110 drive motor rotates a rotor, compression assembly, or other mechanical pumping element that drives fluid movement within a pump 110. In a non-limiting example, motor revolutions per minute may be measured using a motor encoder, tachometer sensor, internal motor controller 116 feedback system, rotational sensor, or other device configured to detect rotational movement of a motor shaft. Without limitation, motor revolutions per minute may be transmitted as digital motor speed 108 data, control feedback data, or operational telemetry received by a computing device such as processor 102. As used in this disclosure, “expected volumetric displacement” is an estimated quantity of fluid displaced by a pump 110 during a single rotational cycle or other defined actuation of the pump 110 mechanism under assumed operating conditions. In an embodiment, expected volumetric displacement 124 may represent a predicted volume of fluid transferred through peristaltic pump tubing 118 when a rotor completes one full revolution that compresses and releases sections of the tubing. In a non-limiting example, the expected volumetric displacement 124 may correspond to approximately 2 milliliters of fluid per rotor revolution for a pump 110 configured with tubing having a particular inner diameter and compression geometry. Without limitation, expected volumetric displacement 124 may be determined using pump design parameters including rotor diameter, tubing dimensions, compression roller spacing, tubing elasticity characteristics, pressure conditions, or other pump configuration properties that influence fluid displacement behavior. In an embodiment, processor 102 may apply a stored relationship that correlates motor revolutions per minute with the expected volumetric displacement 124 associated with operation of the pump 110. For example, without limitation, if the expected volumetric displacement 124 corresponds to 3 milliliters of fluid per rotor revolution and the motor speed 108 is detected at 50 revolutions per minute, processor 102 may determine that the predicted fluid flow rate 122 corresponds to approximately 150 milliliters per minute of delivered chemical. In another non-limiting example, the relationship may be represented by a calibration table stored in memory 104 that associates motor speed 108 ranges with expected pump output values. For instance, without limitation, the stored relationship may indicate that operation at 30 revolutions per minute corresponds to approximately 90 milliliters per minute of chemical delivery, operation at 60 revolutions per minute corresponds to approximately 180 milliliters per minute, and operation at 90 revolutions per minute corresponds to approximately 270 milliliters per minute. Processor 102 may reference the stored relationship using received motor speed 108 data to determine the predicted fluid flow rate 122 generated by the pump 110.

Still referring to FIG. 1, processor 102 is configured to determine an actual fluid consumption 126 based on the at least a measurement indicative of fluid flow from the fluid storage container 114. As used in this disclosure, “at least a measurement indicative of fluid flow” is one or more sensed, derived, or calculated parameters that directly or indirectly represent, correlate with, or enable determination of a volumetric or mass flow rate of a fluid over time, including measurements that do not themselves constitute a direct flow rate measurement but from which fluid flow can be inferred. In a non-limiting example, at least a measurement indicative of fluid flow may include a direct flow rate measurement obtained from a flow sensor, such as a turbine flow meter, electromagnetic flow meter, ultrasonic flow meter, or Coriolis flow meter. In a non-limiting example, at least a measurement indicative of fluid flow may include a fluid level measurement within a storage container over time, wherein a change in fluid level is used to determine a volumetric flow rate. In a non-limiting example, at least a measurement indicative of fluid flow may include a weight measurement of a container using a load cell, wherein a change in weight over time corresponds to a mass flow rate. In a non-limiting example, at least a measurement indicative of fluid flow may include a pressure differential across a restriction, such as an orifice plate or venturi, wherein the pressure differential is correlated with flow rate. In a non-limiting example, at least a measurement indicative of fluid flow may include pump operational parameters, including motor speed, torque, or power consumption, used in conjunction with a pump model to estimate flow rate. In a non-limiting example, at least a measurement indicative of fluid flow may include timing information associated with discrete dispensing events, such as valve open duration or pump actuation time, used to infer delivered fluid volume and corresponding flow rate. Without limitation, the at least a measurement indicative of fluid flow comprises a time-based fluid level measurement of the fluid storage container 114. As used in this disclosure, a “time-based fluid level measurement” is a measurement of a fluid level within a container that is obtained at two or more points in time, wherein a change in the fluid level over the time interval is used to determine, estimate, or infer a fluid flow rate or fluid consumption. In a non-limiting example, a time-based fluid level measurement may include measuring a fluid level in a storage tank at a first time and at a second time using a level sensor, such as an ultrasonic level sensor, wherein the fluid level decreases from 100 liters at the first time to 80 liters at the second time over a 10-minute interval, and wherein the change in fluid level over the time interval is used to determine a fluid flow rate of approximately 2 liters per minute. As used in this disclosure, “actual fluid consumption” is a measured quantity of fluid that has been removed from a fluid storage container 114 during a defined time interval based on detected changes in fluid level within the container. In an embodiment, actual fluid consumption 126 may represent a calculated volume of chemical dispensed by a pump 110 as determined from sensor measurements indicating a reduction in stored fluid quantity. In a non-limiting example, actual fluid consumption 126 may be determined by measuring a difference between a first fluid level measurement obtained at a first time and a second fluid level measurement obtained at a later time. Without limitation, actual fluid consumption 126 may be expressed as a volumetric value, a volumetric flow rate, a cumulative quantity of fluid dispensed, or another calculated metric derived from fluid level measurements 112. In an embodiment, processor 102 may determine the actual fluid consumption 126 by receiving sequential fluid level measurements 112 generated by a level sensor 120 associated with the fluid storage container 114 and calculating a difference between the measurements over a defined time interval. The calculated difference in fluid level may correspond to a quantity of fluid removed from the container during operation of the pump 110. In a non-limiting example, the level sensor 120 may report that the fluid storage container 114 contains 10,000 milliliters of chemical at a first measurement time and 9,850 milliliters of chemical at a second measurement time occurring 1 minute later. Processor 102 may determine that 150 milliliters of fluid were removed from the container during the 1 minute interval and may therefore determine that the actual fluid consumption 126 corresponds to approximately 150 milliliters per minute during that time period. In another non-limiting example, processor 102 may determine actual fluid consumption 126 using fluid level measurements 112 expressed as fluid height within the container. For instance, without limitation, the level sensor 120 may indicate that the fluid height decreased from 50 centimeters to 49.5 centimeters during a measurement interval. Processor 102 may apply a stored container geometry model that correlates fluid height with container volume in order to determine that the observed height change corresponds to a volumetric reduction of approximately 120 milliliters of chemical. In another non-limiting example, processor 102 may determine actual fluid consumption 126 using container mass measurements obtained from a load cell associated with the fluid storage container 114. For example, without limitation, the load cell may indicate that the container mass decreased from 20,000 grams to 19,850 grams during a 1 minute interval. Processor 102 may determine that approximately 150 grams of chemical were dispensed and may convert the mass value into a volumetric consumption value using a stored density value associated with the chemical. In an embodiment, processor 102 may repeatedly determine actual fluid consumption 126 at successive measurement intervals so that fluid usage trends may be monitored during pump operation. The calculated actual fluid consumption 126 values may be compared with predicted fluid flow rate 122 values determined based on motor speed 108 in order to identify discrepancies between expected pump output and measured chemical depletion from the container. Such discrepancies may indicate progressive degradation of peristaltic pump tubing 118 or other mechanical components influencing pump performance, thereby enabling processor 102 to update trim calibration parameters that maintain accurate chemical dosing.

With continued reference to FIG. 1, determining the actual fluid consumption 126 may include determining the actual fluid consumption 126 based on a change in the fluid level measurement over a time interval. As used in this disclosure, “change” is a measurable difference between two values of a parameter determined at different points in time. In an embodiment, the change may represent a difference between a first measured fluid level value and a second measured fluid level value obtained after operation of a pump 110 for a period of time. In a non-limiting example, the change may correspond to a reduction in fluid volume within a storage container that occurs as fluid is dispensed by a pump 110 during operation. Without limitation, the change may be expressed as a difference in volumetric measurements, fluid height measurements, container mass measurements, sensor output values, or other measurable parameters representing a quantity of fluid stored within the container. As used in this disclosure, “time interval” is a defined duration between a first point in time at which a measurement is obtained and a second point in time at which a subsequent measurement is obtained. In an embodiment, the time interval may correspond to a measurement sampling period used by a processor 102 to evaluate changes in system parameters over time. In a non-limiting example, the time interval may correspond to 10 seconds, 30 seconds, 1 minute, 5 minutes, 10 minutes, or another defined duration during which pump operation occurs and fluid level measurements 112 are collected. Without limitation, the time interval may be predetermined, dynamically adjusted during operation, or selected based on pump operating conditions, sensor sampling frequency, or system monitoring requirements. In an embodiment, processor 102 may determine the change in the fluid level measurement by comparing a first level sensor 120 measurement obtained at a first time with a second level sensor 120 measurement obtained at a later time. The difference between the two measurements may correspond to a quantity of fluid dispensed from the fluid storage container 114 during operation of the pump 110. In a non-limiting example, the level sensor 120 may report that the fluid storage container 114 contains 10,000 milliliters of chemical at time 0 seconds and 9,850 milliliters of chemical at time 60 seconds. Processor 102 may determine that a change of 150 milliliters occurred over a time interval of 60 seconds and may therefore determine that the actual fluid consumption 126 corresponds to approximately 150 milliliters per minute. In another non-limiting example, the level sensor 120 may measure fluid height within the storage container. For instance, without limitation, the level sensor 120 may indicate that the fluid height decreased from 50 centimeters at time 0 seconds to 49.7 centimeters at time 120 seconds. Processor 102 may apply a stored container geometry relationship to determine that the observed change in height corresponds to approximately 90 milliliters of fluid removed during the 120 second time interval. In another non-limiting example, the fluid storage container 114 may be positioned on a load cell that measures container mass. For example, without limitation, the load cell may indicate that the container mass decreased from 20,000 grams at time 0 seconds to 19,880 grams at time 60 seconds. Processor 102 may determine that a change of 120 grams occurred during the 60 second time interval and may convert the measured mass change into a volumetric consumption value using a stored density value associated with the chemical. In an embodiment, processor 102 may repeatedly evaluate the change in fluid level measurements 112 across successive time intervals during operation of the pump 110. The resulting consumption measurements may be used to determine the actual fluid consumption 126 associated with pump operation and may be compared with predicted fluid flow rate 122 values in order to identify discrepancies that may indicate degradation of peristaltic pump tubing 118 or other pump system components.

Still referring to FIG. 1, processor 102 is configured to compare the predicted fluid flow rate 122 with the actual fluid consumption 126 to determine a discrepancy value 128. As used in this disclosure, “discrepancy value” is a calculated measurement representing a difference between a predicted fluid flow rate 122 and an actual fluid consumption 126. In an embodiment, the discrepancy value 128 may be determined from sensor measurements. In an embodiment, the discrepancy value 128 may indicate a deviation between an expected quantity of fluid that should have been delivered by a pump 110 based on motor operating parameters and a measured quantity of fluid that was actually removed from a fluid storage container 114. In a non-limiting example, the discrepancy value 128 may correspond to a numerical difference between predicted fluid delivery and measured chemical consumption determined during a defined time interval. Without limitation, the discrepancy value 128 may be expressed as a volumetric difference value, a percentage deviation value, a ratio value, an error coefficient, or another calculated parameter representing a difference between expected and measured pump output. In an embodiment, processor 102 may determine the discrepancy value 128 by subtracting the actual fluid consumption 126 from the predicted fluid flow rate 122 determined for a corresponding time interval. The resulting difference may indicate whether the pump 110 delivered more fluid or less fluid than expected based on the detected motor speed 108. In a non-limiting example, processor 102 may determine that the predicted fluid flow rate 122 corresponds to 150 milliliters of expected chemical delivery during a 1 minute interval based on the detected motor speed 108. If the processor 102 determines from tank level measurements that the actual fluid consumption 126 during the same 1 minute interval corresponds to 135 milliliters, processor 102 may determine a discrepancy value 128 of 15 milliliters representing an under delivery condition. In another non-limiting example, processor 102 may determine that the predicted fluid flow rate 122 corresponds to 200 milliliters during a defined measurement interval while the actual fluid consumption 126 determined from level sensor 120 measurements corresponds to 220 milliliters. Processor 102 may determine a discrepancy value 128 of 20 milliliters representing an over delivery condition in which the pump 110 delivered more chemical than expected. In another non-limiting example, processor 102 may determine the discrepancy value 128 as a percentage deviation between predicted and measured values. For instance, without limitation, if the predicted fluid flow rate 122 corresponds to 150 milliliters and the actual fluid consumption 126 corresponds to 135 milliliters, processor 102 may determine that the pump 110 delivered approximately 10 percent less fluid than expected during the measurement interval. In an embodiment, processor 102 may repeatedly determine discrepancy values during successive time intervals while the pump 110 is operating. The determined discrepancy values may be stored in memory 104 and may be used to identify gradual changes in pump performance that occur due to degradation of peristaltic pump tubing 118, changes in fluid viscosity, pressure variations within fluid delivery lines, or other operational factors influencing pump output. Processor 102 may use the discrepancy value 128 to generate or update a trim coefficient 130 that adjusts motor speed 108 in order to compensate for the detected deviation and maintain accurate chemical delivery.

Still referring to FIG. 1, processor 102 is configured to generate a trim coefficient 130 based on the discrepancy value 128. As used in this disclosure, “trim coefficient” is a calculated adjustment factor configured to modify a pump 110 operating parameter in order to compensate for a detected discrepancy between predicted fluid flow rate 122 and actual fluid consumption 126. In an embodiment, the trim coefficient 130 may represent a scaling value applied to a commanded motor speed 108 so that the effective fluid delivery produced by the pump 110 more closely corresponds to an intended target delivery volume. In a non-limiting example, the trim coefficient 130 may increase or decrease the motor rotational speed used to drive a pump 110 in response to a discrepancy value 128 indicating under delivery or over delivery of fluid. Without limitation, the trim coefficient 130 may be expressed as a multiplicative scaling factor 144, an additive adjustment parameter, a percentage correction value, or another calibration parameter used to modify pump operation. As used in this disclosure, “pump operating parameter” is a measurable or controllable variable associated with operation of a pump 110 that may influence or indicate the performance of the pump 110 during fluid delivery. In an embodiment, a pump 110 operating parameter may represent a characteristic of pump operation that can be monitored, adjusted, or processed by a computing device in order to evaluate pump behavior or regulate fluid delivery. In a non-limiting example, a pump 110 operating parameter may include motor rotational speed, pump runtime duration, pump duty cycle, commanded dosing rate, pump activation state, or pump rotational direction and the like. Without limitation, a pump 110 operating parameter may further include environmental or system conditions affecting pump performance including fluid viscosity, line pressure, tubing elasticity characteristics, temperature conditions, motor current consumption, torque measurements, or other operational measurements associated with pump performance. In an embodiment, processor 102 may determine the trim coefficient 130 by analyzing the magnitude and direction of the discrepancy value 128 calculated between predicted fluid flow rate 122 and actual fluid consumption 126. The processor 102 may generate a correction factor that modifies the motor speed 108 used to operate the pump 110 so that future fluid delivery more accurately corresponds to the predicted or desired delivery amount. In a non-limiting example, processor 102 may determine that the predicted fluid flow rate 122 during a 1 minute interval corresponds to 150 milliliters while the actual fluid consumption 126 measured from tank level data corresponds to 135 milliliters. Processor 102 may determine that the pump 110 is under delivering fluid by 15 milliliters and may generate a trim coefficient 130 of approximately 1.11 so that the commanded motor speed 108 is increased by approximately 11 percent in subsequent pump operation. In another non-limiting example, processor 102 may determine that predicted fluid flow rate 122 corresponds to 200 milliliters during a defined interval while the measured actual fluid consumption 126 corresponds to 220 milliliters. Processor 102 may determine that the pump 110 is over delivering fluid by 20 milliliters and may generate a trim coefficient 130 of approximately 0.91 so that the commanded motor speed 108 is reduced by approximately 9 percent during subsequent pump operation. In another non-limiting example, processor 102 may generate the trim coefficient 130 using an averaging process applied across multiple discrepancy values determined during successive measurement intervals. For instance, without limitation, processor 102 may evaluate discrepancy values determined during 5 consecutive measurement intervals and may compute an average correction factor representing the overall deviation between predicted pump output and measured chemical consumption. The averaged correction factor may then be stored as the trim coefficient 130 used to adjust motor speed 108 during future pump operation. In an embodiment, the trim coefficient 130 may be periodically updated as additional pump operational data 106 becomes available. Processor 102 may repeatedly compare predicted fluid flow rate 122 with measured fluid consumption and may update the trim coefficient 130 to compensate for progressive changes in pump performance caused by wear of peristaltic pump tubing 118, changes in fluid properties, pressure variations within delivery lines, or other mechanical or environmental conditions affecting pump displacement behavior.

With continued reference to FIG. 1, generating the trim coefficient 130 may further include training a machine-learning model 132 using trim training data 134, wherein the trim training data 134 comprises historical motor speed data 136 corresponding to historical fluid level measurements 138, and historical discrepancy values 140 determined based on differences between predicted fluid flow rate 122 derived from the historical motor speed data 136 and actual fluid consumption 126 derived from the historical fluid level measurements 138 and retraining the machine-learning model 132 using updated pump operational data 142 and subsequently determined discrepancy values to generate the trim coefficient 130. As used in this disclosure, “trim training data” is a collection of historical operational measurements associated with pump operation that are used to train a machine-learning model 132 to generate or update a trim coefficient 130. In an embodiment, trim training data 134 may include motor operating parameters, fluid level measurements 112, calculated fluid consumption values, and discrepancy values determined from prior pump operation. In a non-limiting example, the trim training data 134 may comprise recorded motor speed 108 values, corresponding tank level measurements, calculated predicted fluid flow rate 122 values, calculated actual fluid consumption 126 values, and discrepancy values derived from differences between predicted and measured fluid delivery. Without limitation, trim training data 134 may be stored within a memory 104 associated with processor 102, within a remote data storage system, within a supervisory control platform, or within a cloud-based data repository used for model training. As used in this disclosure, “historical motor speed data” is previously recorded measurements representing motor revolutions per minute associated with prior pump operation. In an embodiment, historical motor speed data 136 may be collected by a motor controller 116, encoder, tachometer sensor, or other rotational sensing device that records motor rotational speed during pump operation. In a non-limiting example, the historical motor speed data 136 may include time-stamped motor speed 108 values such as 30 revolutions per minute, 45 revolutions per minute, 60 revolutions per minute, and 75 revolutions per minute recorded during prior pump operation cycles. Without limitation, the historical motor speed data 136 may be stored in memory 104 together with corresponding timestamps, operational states of the pump 110, and associated sensor measurements. As used in this disclosure, “historical fluid level measurements” are previously recorded measurements representing a quantity or height of fluid contained within a fluid storage container 114 during prior pump operation. In an embodiment, the historical fluid level measurements 138 may be generated by a level sensor 120 associated with the fluid storage container 114 and recorded at successive measurement times during operation of the pump 110. In a non-limiting example, the historical fluid level measurements 138 may indicate that a storage container contained 10,000 milliliters of chemical at a first time, 9,900 milliliters at a second time, and 9,780 milliliters at a third time during prior pump operation. Without limitation, the historical fluid level measurements 138 may be stored together with associated timestamps so that a computing device may determine changes in stored fluid quantity across measurement intervals. As used in this disclosure, “historical discrepancy values” are previously calculated values representing differences between predicted fluid flow rate 122 and actual fluid consumption 126 determined during prior pump operation intervals. In an embodiment, historical discrepancy values 140 may be generated by comparing predicted fluid flow rate 122 values derived from historical motor speed data 136 with actual fluid consumption 126 values derived from historical fluid level measurements 138. In a non-limiting example, a predicted fluid delivery value of 150 milliliters during a measurement interval may correspond to an actual measured consumption of 135 milliliters, resulting in a historical discrepancy value of 15 milliliters representing under delivery during that interval. Without limitation, historical discrepancy values 140 may be stored as volumetric differences, percentage deviations, scaling coefficients, or other calculated error metrics used for model training. As used in this disclosure, “updated pump operational data” is newly received or generated operational information associated with ongoing or recent pump operation that is used to update or retrain a machine-learning model 132. In an embodiment, updated pump operational data 142 may include newly received motor speed 108 measurements, pump runtime information, fluid level measurements 112 obtained from the fluid storage container 114, predicted fluid flow rate 122 values, actual fluid consumption 126 values, and other pump performance indicators. In a non-limiting example, updated pump operational data 142 may include motor speed 108 values of 55 revolutions per minute recorded during a recent pump cycle together with corresponding fluid level measurements 112 indicating a reduction in stored chemical volume within the container. Without limitation, updated pump operational data 142 may be periodically collected during pump operation and may be used to update model parameters to reflect current pump behavior. As used in this disclosure, “subsequently determined discrepancy values” are discrepancy values calculated after initial training of a machine-learning model 132 using newly received operational data obtained during ongoing pump operation. In an embodiment, subsequently determined discrepancy values may be calculated by comparing predicted fluid flow rate 122 values derived from updated motor speed 108 measurements with actual fluid consumption 126 values determined from newly received fluid level measurements 112. In a non-limiting example, processor 102 may determine that predicted fluid flow rate 122 during a recent interval corresponds to 160 milliliters while actual fluid consumption 126 corresponds to 145 milliliters, resulting in a subsequently determined discrepancy value of 15 milliliters that may be used to update the machine-learning model 132. Without limitation, subsequently determined discrepancy values may be incorporated into model retraining processes to improve accuracy of trim coefficient 130 predictions as pump performance characteristics change over time.

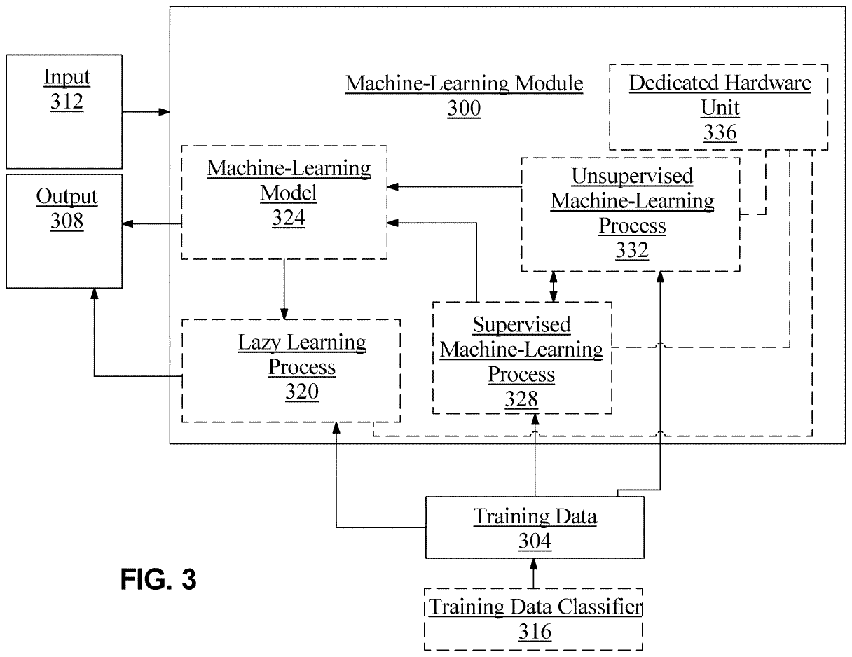

With continued reference to FIG. 1, in an embodiment, the machine-learning model 132 used to generate the trim coefficient 130 may be the same as or similar to any of the machine-learning models described with reference to FIGS. 3-5. The machine-learning model 132 may be trained using the trim training data 134 to learn relationships between motor operating parameters, measured fluid consumption behavior, and resulting discrepancy values associated with pump performance. In a non-limiting example, the machine-learning model 132 may receive historical motor speed data 136 values such as 30 revolutions per minute, 50 revolutions per minute, and 70 revolutions per minute together with corresponding historical fluid level measurements 138 that indicate reductions in stored chemical volume within the fluid storage container 114. The model may analyze the historical discrepancy values 140 associated with those operating conditions and learn patterns indicating how pump performance deviates from predicted fluid flow rate 122 over time. The machine-learning model 132 may further be retrained using updated pump operational data 142 and subsequently determined discrepancy values to generate the trim coefficient 130. In an embodiment, processor 102 may periodically provide newly collected motor speed 108 data, newly measured fluid level values, and newly calculated discrepancy values to the machine-learning model 132 so that the model may update its internal parameters. The retrained machine-learning model 132 may generate an updated trim coefficient 130 representing a correction factor that compensates for observed pump performance deviations. In this manner, the machine-learning model 132 may adaptively refine the trim coefficient 130 as pump tubing degradation, fluid characteristics, environmental conditions, or other operational factors influence the relationship between motor speed 108 and delivered fluid volume.

With continued reference to FIG. 1, generating the trim coefficient 130 may include determining a scaling factor 144 configured to modify the motor speed 108 of the pump 110. As used in this disclosure, “scaling factor” is a numerical adjustment value applied to an operating parameter in order to proportionally increase or decrease the magnitude of that operating parameter. In an embodiment, the scaling factor 144 may be used to modify a motor speed 108 associated with a pump 110 so that the resulting pump output more closely corresponds to a desired fluid delivery value. In a non-limiting example, the scaling factor 144 may be applied as a multiplicative value that increases or decreases a commanded motor rotational speed used to drive a pump 110. Without limitation, the scaling factor 144 may be determined based on measured performance deviations between predicted fluid flow rate 122 and actual fluid consumption 126 and may represent a correction value used to compensate for pump performance drift. The scaling factor 144 may represent a proportional adjustment that modifies the motor revolutions per minute used to operate the pump 110 so that subsequent fluid delivery more closely matches an intended delivery amount. In a non-limiting example, processor 102 may determine that predicted fluid flow rate 122 during a measurement interval corresponds to 150 milliliters while the actual fluid consumption 126 corresponds to 135 milliliters. Processor 102 may determine that the pump 110 delivered approximately 90 percent of the expected fluid volume. Based on this discrepancy, processor 102 may determine a scaling factor 144 of approximately 1.11 so that the motor speed 108 is increased by approximately 11 percent in order to compensate for the detected under delivery. In another non-limiting example, processor 102 may determine that predicted fluid flow rate 122 corresponds to 200 milliliters while measured actual fluid consumption 126 corresponds to 220 milliliters during a corresponding measurement interval. Processor 102 may determine that the pump 110 delivered approximately 110 percent of the expected fluid volume and may determine a scaling factor 144 of approximately 0.91 so that the commanded motor speed 108 is reduced by approximately 9 percent in order to compensate for the over delivery condition. In an embodiment, the scaling factor 144 may be applied to a baseline motor speed 108 value used to operate the pump 110. For example, without limitation, if the commanded motor speed 108 corresponds to 60 revolutions per minute and processor 102 determines a scaling factor 144 of 1.10, processor 102 may determine an adjusted motor speed 108 of approximately 66 revolutions per minute. The adjusted motor speed 108 may then be transmitted to a motor controller 116 so that the pump 110 operates at the corrected rotational speed. In another non-limiting example, processor 102 may update the scaling factor 144 periodically based on newly determined discrepancy values generated during ongoing pump operation. The updated scaling factor 144 may reflect progressive changes in pump performance caused by degradation of peristaltic pump tubing 118, changes in fluid viscosity, pressure conditions within fluid delivery lines, temperature variations, and the like. By applying the scaling factor 144 to the motor speed 108, processor 102 may dynamically adjust pump operation so that the delivered chemical volume remains substantially consistent with a target dosing value despite mechanical wear or changing operating conditions. In an embodiment, the scaling factor 144 may be determined using a ratio between the predicted fluid flow rate 122 and the actual fluid consumption 126 measured from the fluid storage container 114. Processor 102 may determine the scaling factor 144 by dividing the predicted fluid flow rate 122 by the measured actual fluid consumption 126 so that the resulting value represents a proportional correction used to adjust motor speed 108. In a non-limiting example, processor 102 may determine that the predicted fluid flow rate 122 during a measurement interval corresponds to 150 milliliters while the measured actual fluid consumption 126 corresponds to 135 milliliters. Processor 102 may divide 150 by 135 to determine a scaling factor 144 of approximately 1.11, which may be applied to increase the motor speed 108 so that subsequent pump operation delivers the intended fluid volume. In another embodiment, the scaling factor 144 may be determined using a proportional correction derived from a percentage deviation between predicted fluid flow rate 122 and actual fluid consumption 126. Processor 102 may determine a percentage difference representing the deviation between expected and measured fluid delivery and may convert the percentage deviation into a scaling factor 144 used to modify motor speed 108. In a non-limiting example, processor 102 may determine that the predicted fluid flow rate 122 corresponds to 200 milliliters while actual fluid consumption 126 corresponds to 180 milliliters during the same time interval. Processor 102 may determine that the pump 110 delivered approximately 10 percent less fluid than expected and may determine a scaling factor 144 of approximately 1.10 that increases the commanded motor speed 108 by approximately 10 percent. In another non-limiting example, the scaling factor 144 may be determined using an averaging process applied to multiple discrepancy values determined across successive time intervals. Processor 102 may calculate discrepancy values corresponding to several recent pump operation intervals and may compute an average correction factor representing a consistent deviation between predicted and measured pump output. For instance, without limitation, processor 102 may determine discrepancy values of 12 milliliters, 15 milliliters, and 18 milliliters across three measurement intervals in which predicted delivery corresponds to approximately 150 milliliters during each interval. Processor 102 may determine an averaged correction ratio corresponding to approximately 1.10 and may determine a scaling factor 144 of approximately 1.10 used to adjust motor speed 108 during subsequent pump operation. In another embodiment, the scaling factor 144 may be determined using a trained computational model or machine-learning model 132 configured to evaluate pump operational data 106. The model may receive inputs including motor revolutions per minute, predicted fluid flow rate 122 values, actual fluid consumption 126 values, discrepancy values, pump runtime information, tubing wear indicators, and the like. The model may analyze the inputs to determine a scaling factor 144 that modifies the commanded motor speed 108 so that the resulting pump output more closely corresponds to a desired delivery volume. In a non-limiting example, the machine-learning model 132 may determine that a pump 110 operating at 60 revolutions per minute with observed discrepancy values indicating under delivery may require a scaling factor 144 of approximately 1.08 in order to compensate for progressive degradation of peristaltic pump tubing 118. In another embodiment, the scaling factor 144 may be determined using a calibration function stored in memory 104 that maps discrepancy values to motor speed 108 adjustments. Processor 102 may reference the calibration function using the calculated discrepancy value 128 to determine a corresponding scaling factor 144. For example, without limitation, the calibration function may specify that a discrepancy value 128 of 10 milliliters during a 1 minute interval corresponds to a scaling factor 144 of 1.07, while a discrepancy value 128 of 20 milliliters corresponds to a scaling factor 144 of 1.14. Processor 102 may apply the calibration function to determine the scaling factor 144 used to adjust the motor speed 108 of the pump 110.

Still referring to FIG. 1, processor 102 is configured to adjust the motor speed 108 of the pump 110 based on the trim coefficient 130 to compensate for a change in volumetric pump efficiency. “Volumetric pump efficiency” as described in this disclosure refers to a measure of an effectiveness of a pump in moving a fluid compared to its theoretical maximum capacity. In one or more embodiments, volumetric pump efficiency (also referred to herein as “pump efficiency”) may quantify how much fluid is “lost” during the pumping process due to internal leakage, backflow, or fluid compression. In a non-limiting example, the processor 102 may determine that a discrepancy exists between a predicted fluid flow rate and an actual fluid consumption, and may generate the trim coefficient 130 based on the discrepancy, wherein the processor 102 adjusts the motor speed 108 of the pump 110 using the trim coefficient 130 to compensate for a change in efficiency of the pump 110, such that variations in pump performance are corrected and a target fluid delivery volume is maintained. In a non-limiting example, the pump 110 may be operating at a motor speed 108 expected to deliver 100 milliliters per minute based on a pump model, but a measured fluid consumption indicates that only 90 milliliters per minute is being delivered, thereby indicating a reduction in efficiency of the pump 110. The processor 102 may generate a trim coefficient 130 representing the discrepancy and adjust the motor speed 108 upward, for example increasing the motor speed 108 by approximately 10%, such that the adjusted motor speed compensates for the efficiency loss and restores the delivered flow rate to approximately 100 milliliters per minute. In an embodiment, the change in pump 110 efficiency may include degradation of the peristaltic pump tubing associated with the pump 110. In a non-limiting example, the change in pump efficiency or volumetric pump efficiency may comprise degradation of the peristaltic pump tubing associated with the pump, wherein repeated compression and relaxation of the tubing during operation causes the tubing to lose elasticity, stiffen, or experience dimensional changes over time, thereby reducing a volume of fluid displaced per pump cycle, such that a given motor speed results in a lower actual fluid flow rate than expected. As used in this disclosure, “degradation” is a gradual reduction in performance characteristics of a mechanical component caused by repeated operational use, environmental exposure, or material fatigue. In an embodiment, degradation may occur when a component experiences physical wear, elastic fatigue, chemical exposure effects, or structural deformation that alters the component's functional behavior over time. In a non-limiting example, degradation may occur in peristaltic pump tubing 118 when repeated compression cycles gradually reduce tubing elasticity, alter tubing shape, or increase permanent deformation of the tubing walls. Without limitation, degradation may also result from exposure to chemicals transported through the tubing, temperature fluctuations, pressure variations, mechanical stress, or prolonged operational runtime that influence tubing material properties. In an embodiment, processor 102 may modify the commanded motor speed 108 used to operate the pump 110 by applying the trim coefficient 130 generated from previously determined discrepancy values. The adjusted motor speed may increase or decrease the rotational rate of the pump 110 drive motor so that the resulting fluid delivery more closely corresponds to a desired chemical dosing quantity. In a non-limiting example, processor 102 may determine that a pump 110 operating at 60 revolutions per minute is expected to deliver approximately 150 milliliters of chemical per minute. If processor 102 determines from fluid level measurements 112 that the pump 110 is delivering approximately 135 milliliters per minute due to degradation of the peristaltic pump tubing 118, processor 102 may apply a trim coefficient 130 of approximately 1.11 and adjust the motor speed 108 to approximately 66 revolutions per minute so that the resulting fluid delivery more closely corresponds to the intended delivery volume. In another non-limiting example, degradation of the peristaltic pump tubing 118 may occur as repeated compression by pump rollers causes gradual flattening or reduced elasticity of the tubing walls. This change in tubing elasticity may reduce the effective volumetric displacement produced during each pump rotation. Processor 102 may detect the resulting discrepancy between predicted fluid flow rate 122 and measured fluid consumption and may increase the motor speed 108 using the trim coefficient 130 so that the pump 110 performs additional rotational cycles during a given time interval to compensate for the reduced displacement per cycle. In another non-limiting example, degradation of the peristaltic pump tubing 118 may occur as repeated compression by pump rollers causes gradual flattening or reduced elasticity of the tubing walls. During operation of a peristaltic pump, rotating rollers repeatedly compress and release segments of the tubing in order to move fluid through the tubing. Over time, the repeated compression cycles may cause elastic fatigue within the tubing material, which may result in permanent deformation, reduced resiliency, or partial flattening of the tubing cross-section. This reduction in elasticity may prevent the tubing from fully returning to its original circular shape after compression, thereby reducing the internal volume of fluid that is displaced during each pump rotation. As a result, the effective volumetric displacement produced by the pump 110 during each rotational cycle may gradually decrease, causing the pump 110 to deliver less fluid than predicted based on motor speed 108. In another non-limiting example, degradation of the peristaltic pump tubing 118 may occur due to chemical interaction between the tubing material and the fluid being transported through the pump 110. Certain chemicals may cause swelling, softening, hardening, or embrittlement of elastomeric tubing materials depending on the chemical composition of the fluid and the material properties of the tubing. Such chemical exposure may alter the mechanical properties of the tubing walls, which may affect how the tubing responds to compression by the pump 110 rollers. These material changes may reduce the consistency of volumetric displacement during each pump cycle and may therefore alter the relationship between motor speed 108 and actual fluid delivery. In another non-limiting example, degradation may occur as a result of temperature exposure during pump operation. Elevated temperatures may accelerate material fatigue or soften elastomeric tubing materials, while low temperatures may cause stiffening or reduced flexibility of the tubing. Changes in tubing flexibility caused by temperature conditions may alter the compression characteristics of the tubing and may therefore influence the amount of fluid displaced during each pump rotation. In another non-limiting example, degradation may occur due to pressure conditions within the fluid delivery system. Backpressure within downstream fluid lines may cause additional mechanical stress on the tubing walls as the pump 110 attempts to push fluid through the system. Sustained pressure conditions may gradually deform the tubing structure or increase mechanical strain experienced during compression cycles, which may contribute to gradual changes in tubing displacement characteristics. In another non-limiting example, degradation may occur due to material fatigue resulting from prolonged operational runtime of the pump 110 system. Continuous or frequent pump operation may subject the tubing to thousands or millions of compression cycles over time, which may gradually reduce the structural integrity and elastic recovery properties of the tubing material. As the tubing material ages and experiences repeated mechanical stress, the volumetric displacement associated with each pump rotation may change, thereby affecting the accuracy of fluid delivery based solely on motor speed 108. In another non-limiting example, degradation may occur due to environmental exposure conditions including ultraviolet light exposure, oxidation, humidity, or contamination present in the operating environment. These environmental factors may alter material properties of the tubing over time, which may influence the tubing's ability to recover its original shape following compression and may therefore impact the volumetric displacement produced during pump operation. In another embodiment, processor 102 may periodically update the adjusted motor speed 108 as additional discrepancy values are determined during ongoing pump operation. The processor 102 may repeatedly evaluate predicted fluid flow rate 122, actual fluid consumption 126, and resulting trim coefficients so that motor speed 108 adjustments adapt to progressive degradation of the peristaltic pump tubing 118. By dynamically modifying motor speed 108 in this manner, the pump 110 system may maintain accurate chemical delivery despite mechanical wear or changing operational conditions.

With continued reference to FIG. 1, adjusting the motor speed 108 of the pump 110 may include increasing the motor speed 108 in response to the discrepancy value 128 indicating reduced fluid delivery due to degradation of the peristaltic pump tubing 118. In an embodiment, processor 102 may determine that the predicted fluid flow rate 122 corresponds to an expected delivery amount based on the detected motor speed 108, while the actual fluid consumption 126 derived from the fluid level measurements 112 indicates that a smaller quantity of fluid was dispensed during the same time interval. Processor 102 may determine that the reduced delivery is caused by degradation of the peristaltic pump tubing 118 and may increase the motor speed 108 so that additional pump rotations occur during the same time interval, thereby restoring the delivered fluid volume to the intended amount. In a non-limiting example, processor 102 may determine that operation of the pump 110 at 60 revolutions per minute is expected to deliver approximately 150 milliliters of chemical per minute. If processor 102 determines from tank level measurements that the actual fluid consumption 126 corresponds to approximately 135 milliliters during the same 1 minute interval, processor 102 may determine that a discrepancy value 128 of 15 milliliters exists. Processor 102 may respond by increasing the motor speed 108 from 60 revolutions per minute to approximately 66 revolutions per minute so that the increased rotational speed compensates for the reduced displacement caused by tubing degradation. In another non-limiting example, processor 102 may determine that predicted fluid flow rate 122 corresponds to approximately 200 milliliters per minute when the pump 110 operates at 80 revolutions per minute. If the actual fluid consumption 126 determined from fluid level measurements 112 indicates that only approximately 170 milliliters were delivered during the same time interval, processor 102 may determine that the pump 110 output has decreased due to changes in tubing elasticity. Processor 102 may increase the motor speed 108 to approximately 94 revolutions per minute so that additional pump rotations compensate for the reduced displacement per rotation. In another non-limiting example, processor 102 may determine that the pump 110 has been operating for an extended period of time and that repeated compression cycles have gradually reduced the elasticity of the peristaltic pump tubing 118. Processor 102 may detect a series of discrepancy values across multiple measurement intervals indicating that the pump 110 consistently delivers less fluid than predicted. In response, processor 102 may incrementally increase the motor speed 108 during successive pump operation cycles. For instance, without limitation, the motor speed 108 may be increased from 50 revolutions per minute to 53 revolutions per minute during a first adjustment, then increased to 56 revolutions per minute during a later adjustment as additional discrepancy values are detected. In another non-limiting example, processor 102 may increase the motor speed 108 dynamically while the pump 110 is operating. Processor 102 may continuously monitor predicted fluid flow rate 122 and actual fluid consumption 126 values derived from tank level measurements and may update the motor speed 108 in near real time. For instance, without limitation, processor 102 may increase motor speed 108 from 70 revolutions per minute to 75 revolutions per minute during active pump operation when the discrepancy value 128 indicates that the pump 110 output has decreased due to progressive degradation of the peristaltic pump tubing 118. By increasing the motor speed 108 in response to the detected discrepancy, processor 102 may maintain accurate chemical delivery without requiring manual recalibration of the pump 110 system.

With continued reference to FIG. 1, in an embodiment, processor 102 may adjust the motor speed 108 of the pump 110 automatically based on the trim coefficient 130 generated from the discrepancy value 128. Processor 102 may transmit an updated motor control command to a motor controller 116 associated with the pump 110, wherein the motor controller 116 adjusts the rotational speed of the motor according to the updated command. In a non-limiting example, processor 102 may determine that the pump 110 is delivering less fluid than predicted and may automatically increase the commanded motor speed 108 from 60 revolutions per minute to 66 revolutions per minute without requiring intervention from a technician. The automatic adjustment may occur during active pump operation or during a subsequent pump activation cycle. In another non-limiting example, processor 102 may adjust the motor speed 108 using a semi-automated process in which a human operator is involved in confirming the adjustment. Processor 102 may determine a recommended motor speed 108 adjustment based on the calculated trim coefficient 130 and may present the recommended adjustment to an operator through a user interface associated with a monitoring system. The operator may review the discrepancy value 128, predicted fluid flow rate 122, and actual fluid consumption 126 measurements before approving or modifying the recommended motor speed 108 adjustment. In another non-limiting example, processor 102 may generate a notification indicating that a discrepancy has been detected and that a motor speed 108 adjustment is recommended. The notification may be transmitted through a notification system configured to alert maintenance personnel or system operators. For example, without limitation, the notification may be transmitted as a graphical alert displayed on a graphical user interface associated with a supervisory control system, a mobile application notification, an electronic mail message, a text message, or a network transmitted alert delivered through a remote monitoring platform. In another non-limiting example, processor 102 may present pump performance data through a graphical user interface that allows an operator to review operational metrics associated with the pump 110 system. The graphical user interface may display predicted fluid flow rate 122 values, actual fluid consumption 126 values, discrepancy values, and a recommended trim coefficient 130 or motor speed 108 adjustment. The operator may manually approve the adjustment through an interface control such as a confirmation button, slider control, input field, or configuration panel. In another non-limiting example, processor 102 may operate within a supervisory control and monitoring system that manages multiple pump systems across a facility. When a discrepancy value 128 is detected indicating reduced fluid delivery, the system may log the event, generate a recommended trim coefficient 130, and either automatically apply the motor speed 108 adjustment or request approval from a system operator through a centralized control interface. The supervisory system may maintain records of the adjustments applied to each pump so that historical performance trends may be analyzed over time. In another embodiment, processor 102 may dynamically update the motor speed 108 during pump operation without requiring manual intervention. The processor 102 may continuously monitor predicted fluid flow rate 122 values and actual fluid consumption 126 measurements derived from level sensor 120 data and may update the motor speed 108 in real time as new discrepancy values are determined. Such automated adjustments may allow the pump 110 system to maintain accurate chemical delivery despite progressive degradation of the peristaltic pump tubing 118 or other mechanical components within the pump 110 system.

Still referring to FIG. 1, processor 102 is configured to generate an output 146 comprising a calibrated pump control signal 148 as a function of the adjusted motor speed 108, wherein the calibrated pump control signal 148 is configured to maintain a target fluid delivery volume 150. As used in this disclosure, “output” is information, data, or a control signal generated by a computing device in response to processing one or more input parameters. In an embodiment, the output 146 may represent a command, instruction, or data value generated by processor 102 that is configured to influence operation of a pump 110 or another component within a fluid delivery system. In a non-limiting example, the output 146 may comprise a control signal transmitted to a motor controller 116, a notification transmitted to a monitoring system, a status value displayed through a graphical user interface, or a logged operational record associated with pump performance and the like. Without limitation, the output 146 may be generated as a digital control command, an analog signal, a network transmitted message, a software instruction executed by a connected device, or another form of machine readable information produced by processor 102. As used in this disclosure, “calibrated pump control signal” is a control signal generated by a computing device that incorporates one or more calibration parameters configured to regulate operation of a pump 110 in order to achieve a desired fluid delivery performance. In an embodiment, the calibrated pump control signal 148 may include a motor speed 108 command that has been adjusted using a trim coefficient 130 or scaling factor 144 derived from comparisons between predicted fluid flow rate 122 and actual fluid consumption 126. In a non-limiting example, the calibrated pump control signal 148 may instruct a motor controller 116 to operate a pump 110 motor at 66 revolutions per minute rather than a baseline value of 60 revolutions per minute in order to compensate for reduced fluid displacement caused by degradation of peristaltic pump tubing 118. Without limitation, the calibrated pump control signal 148 may include updated motor speed 108 parameters, pump duty cycle values, pump runtime commands, or other operational parameters used to control pump behavior. As used in this disclosure, “target fluid delivery volume” is an intended quantity of fluid that a pump 110 is configured to deliver during operation within a defined time interval or dosing event. In an embodiment, the target fluid delivery volume 150 may correspond to a predetermined chemical dosing amount required for a treatment process, manufacturing process, water treatment process, sanitation process, or another fluid dispensing application. In a non-limiting example, the dispensing application may be consistent with one or more aspects of the dispensing system for a car wash as described in attorney docket number 1469-074USU1, U.S. Pat. App. Ser. No. ______, filed on May XX, XXXX, titled “DISPENSING SYSTEMS AND METHODS OF USE,” which is incorporated by reference herein in its entirety. In a non-limiting example, the target fluid delivery volume 150 may correspond to 150 milliliters of chemical delivered per minute, 500 milliliters delivered during a dosing cycle, or 2000 milliliters delivered during a defined treatment interval. Without limitation, the target fluid delivery volume 150 may be defined by a user configuration setting, a process control parameter, a programmable dosing schedule, a supervisory control instruction, or a stored operational parameter associated with the pump 110 system. In an embodiment, processor 102 may generate the output 146 by computing an adjusted motor speed 108 based on the trim coefficient 130 determined from the discrepancy value 128 and incorporating the adjusted motor speed 108 into the calibrated pump control signal 148 transmitted to the motor controller 116. Processor 102 may retrieve a baseline motor speed 108 associated with the target fluid delivery volume 150 and may multiply the baseline motor speed 108 by the trim coefficient 130 to determine an adjusted motor speed 108 value. The adjusted motor speed 108 may then be encoded within a control command transmitted to the motor controller 116. In a non-limiting example, processor 102 may determine that the target fluid delivery volume 150 corresponds to approximately 150 milliliters per minute and that the baseline motor speed 108 required to achieve this delivery volume corresponds to 60 revolutions per minute. If processor 102 determines that the pump 110 is delivering only 135 milliliters per minute due to degradation of the peristaltic pump tubing 118, processor 102 may determine a trim coefficient 130 of approximately 1.10. Processor 102 may generate a calibrated pump control signal 148 instructing the motor controller 116 to operate the pump 110 motor at approximately 66 revolutions per minute so that the resulting pump output more closely corresponds to the target fluid delivery volume 150. In another non-limiting example, processor 102 may transmit the calibrated pump control signal 148 through a communication interface to the motor controller 116 using an industrial control protocol. The motor controller 116 may receive the calibrated pump control signal 148 and may adjust electrical power delivered to the pump 110 motor so that the motor rotates at the adjusted speed defined by the control signal. In another embodiment, processor 102 may generate the output 146 as part of a supervisory monitoring process that manages multiple pumps within a facility. The processor 102 may compute the calibrated pump control signal 148 and may transmit the signal through a network to a distributed motor control system associated with the pump 110. The distributed control system may apply the updated motor speed 108 command so that the pump 110 continues delivering chemical at the target fluid delivery volume 150 despite progressive degradation of peristaltic pump tubing 118 or other mechanical components affecting pump displacement behavior.

With continued reference to FIG. 1, the memory 104 may further include instructions configuring the at least a processor 102 to periodically update the trim coefficient 130 during operation of the pump 110. In an embodiment, processor 102 may repeatedly evaluate pump operational data 106 obtained during active operation of the pump 110 in order to refine the trim coefficient 130 as system conditions change over time. The processor 102 may retrieve updated motor speed 108 measurements, fluid level measurements 112, predicted fluid flow rate 122 values, and actual fluid consumption 126 values at successive time intervals and may compute updated discrepancy values representing differences between predicted and measured fluid delivery. In a non-limiting example, processor 102 may determine the trim coefficient 130 using pump operational data 106 collected during a first measurement interval and may apply the trim coefficient 130 when generating motor control commands during a subsequent pump operation cycle. As additional pump operational data 106 becomes available during later measurement intervals, processor 102 may recompute the discrepancy value 128 and determine whether further adjustments to the trim coefficient 130 are required. The processor 102 may update the stored trim coefficient 130 so that the correction applied to the motor speed 108 reflects the most recent pump performance conditions. In another non-limiting example, processor 102 may update the trim coefficient 130 according to a defined update schedule associated with the pump 110 monitoring process. The processor 102 may analyze pump operational data 106 collected at periodic intervals such as every 30 seconds, every 60 seconds, every 5 minutes, or another defined monitoring interval. At each update interval, processor 102 may determine whether the discrepancy value 128 indicates that the pump 110 is delivering more fluid or less fluid than predicted and may adjust the trim coefficient 130 accordingly. In another non-limiting example, processor 102 may update the trim coefficient 130 using a moving average or smoothing process applied to multiple discrepancy values determined across successive measurement intervals. The processor 102 may analyze a series of recent discrepancy values and may determine an averaged correction factor representing a consistent deviation between predicted fluid flow rate 122 and measured fluid consumption. The averaged correction factor may then be stored as the updated trim coefficient 130 used when adjusting the motor speed 108 of the pump 110. In another embodiment, processor 102 may update the trim coefficient 130 dynamically during pump operation without requiring manual recalibration by a technician. The processor 102 may continuously monitor predicted fluid flow rate 122 values derived from motor speed 108 measurements and actual fluid consumption 126 values derived from level sensor 120 measurements. As new operational data is received, processor 102 may compute updated discrepancy values and may adjust the trim coefficient 130 in near real time so that the pump 110 control parameters adapt to progressive degradation of the peristaltic pump tubing 118 or other mechanical components influencing pump displacement characteristics. In another non-limiting example, processor 102 may store previously determined trim coefficients and associated pump operational data 106 within memory 104 so that historical performance trends may be evaluated over time. The stored historical data may allow processor 102 to determine whether pump performance is gradually changing due to mechanical wear, chemical exposure, temperature conditions, pressure conditions, or other operational factors affecting the pump 110 system. Without limitation, based on the evaluated trends, processor 102 may update the trim coefficient 130 to maintain accurate chemical delivery throughout continued operation of the pump 110.

With continued reference to FIG. 1, the instructions may further configure the at least a processor 102 to transmit the calibrated pump control signal 148 to the motor controller 116 and control the pump 110 using the motor controller 116 based on the transmitted calibrated pump control signal 148. In an embodiment, the motor controller 116 may receive control signals from a computing device such as processor 102 and may adjust motor operating parameters including rotational speed, torque, direction of rotation, or activation state of the motor. In a non-limiting example, the motor controller 116 may comprise a variable frequency drive, a stepper motor driver, a brushless direct current motor controller 116, a programmable logic controller output module, a motor drive circuit, or another electronic control device capable of regulating motor operation and the like. Without limitation, the motor controller 116 may further generate feedback data associated with motor performance including motor revolutions per minute, current consumption, voltage levels, torque indicators, fault status information, and the like, which may be transmitted to processor 102 for monitoring and control purposes. In an embodiment, the calibrated pump control signal 148 generated by processor 102 may be transmitted to the motor controller 116 through a communication interface associated with the computing device. The communication interface may allow processor 102 to transmit motor speed 108 commands or other pump control parameters that instruct the motor controller 116 to operate the pump 110 at a specified rotational speed determined using the trim coefficient 130. In a non-limiting example, the calibrated pump control signal 148 may be transmitted through a wired electrical connection between processor 102 and the motor controller 116. The wired connection may include digital communication buses, serial communication interfaces, industrial control communication lines, analog signal wiring, Ethernet communication links, or other physical communication pathways capable of transmitting control commands between electronic devices. In another non-limiting example, processor 102 may transmit the calibrated pump control signal 148 using an industrial communication protocol. For instance, without limitation, the control signal may be transmitted using Modbus communication, Controller Area Network communication, Ethernet based industrial communication, serial communication protocols, fieldbus communication systems, or other industrial control communication protocols and the like. The motor controller 116 may receive the transmitted command and may adjust electrical power delivered to the motor so that the motor rotates at the specified speed. In another embodiment, the calibrated pump control signal 148 may be transmitted through a wireless communication interface. Processor 102 may transmit the control signal through wireless communication technologies including wireless local area network communication, Bluetooth communication, cellular communication, radio frequency telemetry, or other wireless communication systems capable of transmitting control commands to a remote motor controller 116. In another non-limiting example, processor 102 may transmit the calibrated pump control signal 148 through an intermediate control system or supervisory control platform. The processor 102 may send the control command to a gateway device, programmable logic controller, distributed control system, or remote monitoring platform that manages operation of multiple pump systems. The intermediate system may relay the command to the motor controller 116 associated with the pump 110 so that the motor controller 116 applies the updated motor speed 108 determined by processor 102. In another embodiment, the motor controller 116 may periodically receive updated control commands during active pump operation. Processor 102 may continuously or periodically compute updated trim coefficients and adjusted motor speeds and may transmit updated calibrated pump control signal(s) 148 at successive time intervals so that the motor controller 116 dynamically adjusts motor operation in response to changing pump performance conditions. This dynamic transmission of control signals may allow the pump 110 system to maintain accurate fluid delivery despite progressive degradation of peristaltic pump tubing 118 or other mechanical components within the pump 110 system.

With continued reference to FIG. 1, in an embodiment, apparatus 100 may generate and display the output 146 associated with operation of the pump 110 system so that system operators or maintenance personnel may monitor pump performance and calibration adjustments. The output 146 generated by processor 102 may include operational information such as predicted fluid flow rate 122 values, actual fluid consumption 126 values, discrepancy values, trim coefficient 130 values, adjusted motor speed 108 commands, system alerts, operational status indicators, and the like. In a non-limiting example, apparatus 100 may include a display device configured to present the output 146 through a user interface accessible to an operator. Without limitation, the user interface may include a graphical user interface. The display device may comprise a touchscreen display integrated with the apparatus 100, a computer monitor connected to a supervisory control system, a mobile device display associated with a monitoring application, a tablet interface, or another visual output interface capable of presenting system information. Processor 102 may generate graphical interface elements that present pump operational data 106 in a format that allows an operator to quickly interpret pump performance and calibration status. In another non-limiting example, the graphical user interface may display predicted fluid flow rate 122 values determined from motor speed 108 measurements alongside actual fluid consumption 126 values determined from fluid level measurements 112 obtained from the fluid storage container 114. The graphical interface may further display the calculated discrepancy value 128 and the trim coefficient 130 applied to adjust the motor speed 108. Such visual output may allow an operator to observe how the adaptive calibration algorithm compensates for degradation of the peristaltic pump tubing 118 during continued operation. In another non-limiting example, apparatus 100 may display a recommended or applied motor speed 108 adjustment generated by processor 102. The graphical user interface may present the baseline motor speed 108, the trim coefficient 130 determined from the discrepancy value 128, and the resulting adjusted motor speed 108 command transmitted to the motor controller 116. The interface may also display a target fluid delivery volume 150 associated with the pump 110 operation so that an operator may verify that the adjusted motor speed 108 maintains the intended dosing performance. In another embodiment, apparatus 100 may present the output 146 in the form of graphical charts, trend plots, or performance dashboards illustrating pump operational behavior over time. For example, without limitation, the display may present a time-based graph showing predicted fluid flow rate 122 values, measured fluid consumption values, and corresponding discrepancy values during successive measurement intervals. Such graphical visualizations may allow operators to identify trends indicating progressive degradation of peristaltic pump tubing 118 or other pump components. In another non-limiting example, apparatus 100 may display notifications or alert messages when discrepancy values exceed predefined thresholds. The graphical user interface may present alert indicators informing an operator that a trim coefficient 130 adjustment has been applied or that pump performance has deviated from expected operating conditions. The interface may further provide interactive controls allowing an operator to review system diagnostics, confirm calibration adjustments, modify pump configuration parameters, or acknowledge system notifications. In another embodiment, the output 146 generated by processor 102 may be displayed locally at the apparatus 100 or remotely through a network-connected monitoring system. The processor 102 may transmit the output 146 data to a remote monitoring platform, supervisory control system, or cloud-based monitoring interface that displays pump performance information across multiple pump installations. Such remote display capabilities may allow maintenance personnel to monitor pump calibration status, review operational metrics, and evaluate system performance across distributed facilities. As used in this disclosure, a “user interface” is a collection of hardware and/or software components configured to enable interaction between a user and a computing device, wherein the user interface facilitates the presentation of data to the user and the reception of input from the user. The user interface may include, without limitation, graphical user interfaces, command-line interfaces, application programming interfaces, voice-based interfaces, haptic interfaces, or augmented reality interfaces. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in an embodiment, the graphical user interface and an event handler may operate together to enable seamless interaction between the user and the apparatus 100. The GUI serves as the visual and interactive layer through which the user engages with the apparatus 100, presenting elements such as buttons, sliders, input fields, and informational displays. The event handler, on the other hand, functions as the underlying mechanism that monitors and responds to user interactions with the GUI. For example, when a user clicks a button on the GUI to request an explanation of a concept, the event handler may detect the click event, identify its context, and trigger the appropriate processes within the apparatus 100 to generate a tailored response. This interplay may ensure dynamic and responsive system behavior, as the event handler processes various input events such as clicks, taps, keystrokes, or voice commands, and relays these inputs to the relevant system components. The GUI subsequently updates to reflect the system's responses, such as displaying output 146, modifying visual elements, or providing real-time feedback. Together, the GUI and event handler create an intuitive and interactive experience, bridging user actions and system functionality to achieve efficient and personalized outcomes.

With continued reference to FIG. 1, an “event handler,” as used in this disclosure, is a module, data structure, function, and/or routine that performs an action in response to an event. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements.

With continued reference to FIG. 1, as used in this disclosure, a “visual element” is a component or feature within a system, display, or interface that conveys information through visual means. In a non-limiting example, the visual element may include text, images, icons, shapes, colors, and/or other graphical components designed to be perceived by the user. In a non-limiting example, the visual element may aid in communication, navigation, and/or interaction with the system. Without limitation, the visual element may be used to enhance user experience, guide behavior, and/or represent data visually in an intuitive or informative way. A visual element may include data transmitted to display device, client device, and/or graphical user interface. In some embodiments, visual element may be interacted with. For example, visual element may include an interface, such as a button or menu. In some embodiments, visual element may be interacted with using a user device such as a smartphone, tablet, smartwatch, or computer.

With continued reference to FIG. 1, in an embodiment, the apparatus 100 and or the downstream device may include a data structure. As used in this disclosure, “data structure” is a way of organizing data represented in a specialized format on a computer configured such that the information can be effectively presented in a graphical user interface. In some cases, the data structure includes any input data. In some cases, the data structure contains data and/or rules used to visualize the graphical elements within a graphical user interface. In some cases, the data structure may include any data described in this disclosure. In some cases, the data structure may be configured to modify the graphical user interface, wherein data within the data structure may be represented visually by the graphical user interface. In some cases, the data structure may be continuously modified and/or updated by processor 102, wherein elements within graphical user interface may be modified as a result. In some cases, processor 102 may be configured to transmit display device and or the downstream device the data structure. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio, and microwave data and/or signals, combinations thereof, and the like, among others. Processor 102 may transmit the data described above to a database wherein the data may be accessed from the database. Processor 102 may further transmit the data above to a display device, client device, or another computing device. The data structure may serve as the organizational framework that stores, retrieves, and manages data required for processing events and updating the GUI. The data structure may act as a bridge between the user's input, captured by the event handler, and the output 146 displayed on the GUI, ensuring that information is handled efficiently and accurately throughout the interaction. For example, without limitation, when a user interacts with a dropdown menu in the GUI to select a topic, the event handler may capture this input and accesses a data structure. The data structure may retrieve the relevant information such as, text explanations, videos, or interactive exercises, and passes it back to the event handler, which may then trigger the appropriate updates to the GUI. In another embodiment, the data structure may also maintain the state of the system, tracking user progress, preferences, and session history. For instance, without limitation, a hash table may store user specific configurations which the event handler references when processing interactions. The GUI may then dynamically adapt to display content aligned with these configurations. This integration may ensure that user inputs are seamlessly translated into meaningful system outputs, with the data structure enabling rapid access, consistency, and scalability throughout the process. As used in this disclosure, a “hash table” is a data structure that stores data in a way that allows for fast retrieval, insertion, and deletion of elements. The hash table may organize data into key-value pairs, where each key is unique and used to identify its corresponding value. A hash table may use a hash function to compute an index, or hash code, from the key, which determines where the key-value pair is stored within an array or list.

With continued reference to FIG. 1, as used in this disclosure, an “interactive element” is a component or feature within a graphical user interface (GUI) that allows users to perform actions, provide input, or engage with the apparatus 100. Interactive elements may be designed to facilitate two-way communication between the user and the system, enabling the user to influence the behavior of the apparatus or obtain feedback in response to their actions. Examples of interactive elements may include buttons, dropdown menus, sliders, checkboxes, input fields, and hyperlinks. More advanced interactive elements may include drag-and-drop interfaces, interactive diagrams, or dynamically updating content areas that respond to user actions in real time. The interactive elements may enhance user engagement by providing intuitive and responsive mechanisms for interacting with the system. Interactive elements may operate by responding to user actions such as clicks, taps, swipes, or keyboard inputs, and triggering predefined system behaviors or processes. The execution of the interactive elements may require a combination of front-end and back-end technologies that work together to provide seamless functionality and user interaction. On the front end, technologies such as HTML and CSS may define the structure, appearance, and layout of the interactive elements, while JavaScript may enable dynamic functionality. For example, without limitation, JavaScript may detect when the user clicks a button and trigger actions or animations. Front-end frameworks like React, Angular, or Vue.js may further enhance development by offering reusable components and efficient rendering mechanisms. On the back end, the system may process the user's input, retrieve the necessary data, and communicate with the front end to provide an appropriate response. APIs may act as a bridge between the front end and back end, facilitating data transfer, such as sending a user's form submission to the server and retrieving processed results. Server-side logic, implemented using languages like Python, Java, or Node.js, may handle input processing and return relevant data. Additional supporting technologies may ensure the smooth operation of interactive elements. Event listeners, for instance, may continuously monitor for specific actions like mouse clicks or text entries, executing code when such events are detected. Efficient data structures, such as hash tables or dictionaries, may store interactive state data, such as user preferences or settings, for quick access and updates. Databases, including MySQL or MongoDB, may manage and store the data required for interactive features, such as user profiles or historical activity. Communication technologies may also help maintain the responsiveness of interactive elements. AJAX (Asynchronous Javascript and XML) may allow the front end to update portions of a web page without requiring a full page reload, enhancing responsiveness. WebSockets may provide real-time interaction capabilities, such as live chats or collaborative tools, by enabling persistent communication between the client and the server. Without limitation, the apparatus 100 may include one or more APIs. As used in this disclosure, an “application programming interface (API)” is a set of defined protocols, tools, and methods that allow different software applications, systems, or components to communicate and interact with each other. An API may act as an intermediary that enables a client application, such as a user-facing app, to send requests to a server or service and receive the necessary responses, facilitating seamless integration and functionality across diverse systems.

With continued reference to FIG. 1, as used in this disclosure, “downstream device” is a device that accesses and interacts with apparatus 100. For instance, and without limitation, downstream device may include a remote device and/or apparatus 100. In a non-limiting embodiment, downstream device may be consistent with a computing device as described in the entirety of this disclosure. Without limitation, the downstream device may include a display device. As used in this disclosure, a “display device” refers to an electronic device that visually presents information to the entity. In some cases, display device may be configured to project or show visual content generated by computers, video devices, or other electronic mechanisms. In some cases, display device may include a liquid crystal display (LCD), a cathode ray tube (CRT), a plasma display, a light emitting diode (LED) display, and any combinations thereof. In a non-limiting example, one or more display devices may vary in size, resolution, technology, and functionality. Display device may be able to show any data elements and/or visual elements as listed above in various formats such as, textural, graphical, video among others, in either monochrome or color. Display device may include, but is not limited to, a smartphone, tablet, laptop, monitor, tablet, and the like. Display device may include a separate device that includes a transparent screen configured to display computer generated images and/or information. In some cases, display device may be configured to present a graphical user-interface (GUI) to a user, wherein a user may interact with a GUI. In some cases, a user may view a GUI through display. Additionally, or alternatively, processor 102 be connected to display device. In one or more embodiments, transmitting the output 146 may include displaying the output 146 at a display device using a visual interface.

With continued reference to FIG. 1, the apparatus 100 is an improvement on existing technology for multiple reasons. In an embodiment, the apparatus 100 is an improvement because the apparatus 100 automatically compensates for performance degradation of peristaltic pump tubing 118 during pump operation without requiring manual recalibration procedures performed by technicians. Conventional pump systems often rely on static calibration parameters that assume a consistent relationship between motor speed 108 and delivered fluid volume. However, as peristaltic pump tubing 118 experiences mechanical wear, chemical exposure, or material fatigue over time, the volumetric displacement associated with each pump rotation may change, which may cause the pump 110 to deliver less fluid than expected. The apparatus 100 improves system performance by dynamically evaluating predicted fluid flow rate 122 and actual fluid consumption 126 in order to detect discrepancies between expected and measured fluid delivery. In another embodiment, the apparatus 100 is an improvement because the apparatus 100 implements an adaptive calibration mechanism that continuously refines pump control parameters during operation of the pump 110. Processor 102 may repeatedly analyze motor speed 108 data and fluid level measurements 112 obtained from a fluid storage container 114 to determine discrepancy values that indicate deviations in pump performance. Based on the detected discrepancy values, processor 102 may generate updated trim coefficients that modify the motor speed 108 used to drive the pump 110. By automatically adjusting motor speed 108 based on measured performance conditions, the apparatus 100 may maintain accurate chemical dosing despite progressive degradation of the peristaltic pump tubing 118. In another embodiment, the apparatus 100 is an improvement because the apparatus 100 reduces maintenance requirements and operational downtime associated with pump recalibration. Conventional systems often require periodic manual calibration performed by maintenance personnel to ensure accurate chemical dosing as pump components wear over time. The adaptive pump trim calibration functionality implemented by apparatus 100 reduces or eliminates the need for manual recalibration by automatically adjusting pump control parameters based on real-time operational measurements. This automated calibration process may improve system reliability and reduce labor costs associated with maintenance operations. In another embodiment, the apparatus 100 is an improvement because the apparatus 100 improves accuracy of fluid delivery within chemical dosing systems. By continuously comparing predicted pump output with actual chemical consumption determined from tank level measurements, processor 102 may detect even small deviations in pump performance. The resulting trim coefficient 130 adjustments allow the system to maintain fluid delivery that closely corresponds to a target fluid delivery volume 150 even as pump components experience mechanical wear or environmental influences. In another embodiment, the apparatus 100 is an improvement because the apparatus 100 enables continuous monitoring and adaptive control of pump performance across extended operational periods. Processor 102 may periodically update trim coefficients during pump operation as new operational data becomes available. This adaptive feedback process allows the system to compensate for gradual performance changes over time, thereby improving long-term accuracy and stability of pump-driven fluid delivery systems. In another embodiment, the apparatus 100 is an improvement because the apparatus 100 enables integration with automated monitoring systems and supervisory control platforms. The apparatus may generate outputs representing pump performance metrics, discrepancy values, trim coefficients, and adjusted motor speed 108 commands that may be displayed through graphical user interfaces or transmitted to remote monitoring systems. Such integration may allow operators to monitor pump performance, review calibration adjustments, and maintain accurate chemical dosing across multiple pump installations within a facility or across distributed operational environments.

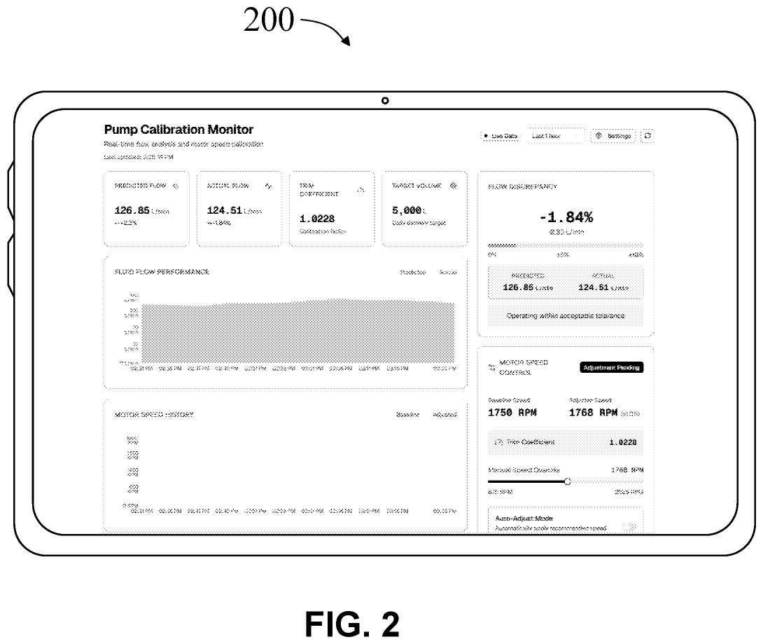

Referring now to FIG. 2, an exemplary illustration 200 of a graphical user interface is shown. In an embodiment, the exemplary illustration 200 may include a pump performance monitoring panel. Without limitation, the pump performance monitoring panel is a visual interface configured to present operational parameters associated with the adaptive pump trim calibration process and may include a predicted fluid flow indicator, an actual fluid consumption indicator, a trim coefficient display, a target fluid delivery volume indicator, and a flow discrepancy value display. The predicted fluid flow indicator may display a value representing an expected chemical delivery rate derived from motor speed measurements, while the actual fluid consumption indicator may display a measured quantity of chemical removed from a fluid storage container as determined from level sensor measurements. In an embodiment, the pump performance monitoring panel may further include a flow discrepancy visualization element configured to present a difference between predicted fluid flow and actual fluid consumption. The flow discrepancy visualization element may display the discrepancy value numerically, graphically, or through visual indicators such as color-coded alerts or status indicators. The visualization may allow an operator to quickly identify whether the pump is delivering more fluid or less fluid than expected based on the predicted operating conditions. In another non-limiting example, the pump performance monitoring panel may include a trim coefficient display configured to present a correction factor generated by a processor. The trim coefficient display may show the calculated scaling value used to modify the motor speed of the pump so that delivered fluid volume corresponds more closely to a target fluid delivery volume. In another embodiment, the exemplary illustration 200 may include a motor control interface. Without limitation, the motor control interface is a visual interface configured to allow monitoring and control of pump motor operation and may include a baseline motor speed indicator, an adjusted motor speed indicator, a motor speed history chart, and a motor speed override control. The baseline motor speed indicator may display a motor speed associated with the predicted fluid flow prior to application of the trim coefficient, while the adjusted motor speed indicator may display a corrected motor speed value calculated using the trim coefficient. In another non-limiting example, the motor control interface may include an override control element configured to allow an operator to manually modify the motor speed if desired. The override control element may comprise a selectable button, slider control, input field, toggle control, or other user interface element that allows an operator to temporarily override automated motor speed adjustments generated by the processor. In another embodiment, the exemplary illustration 200 may include a graphical performance diagram. Without limitation, the graphical performance diagram may present time-based charts illustrating pump operational behavior over time. The diagram may include a predicted fluid flow curve, an actual fluid consumption curve, and a discrepancy trend indicator plotted across successive time intervals. The graphical diagram may allow operators to visualize performance trends indicating gradual degradation of peristaltic pump tubing or other mechanical components influencing pump output. In another non-limiting example, the exemplary illustration 200 may include a motor speed history visualization that displays historical motor speed values across prior operational intervals. The visualization may illustrate changes in baseline motor speed and adjusted motor speed values resulting from trim coefficient updates applied by the processor. Such graphical information may allow an operator to observe how the adaptive calibration process adjusts pump operation over time in response to detected discrepancies between predicted and actual fluid delivery.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data used by machine-learning module may correlate any input data as described in this disclosure to any output data as described in this disclosure. As a non-limiting illustrative example, the machine-learning module may receive input data including motor revolutions per minute associated with operation of a pump, predicted fluid flow values derived from the motor revolutions per minute, fluid level measurements obtained from a level sensor associated with a fluid storage container, calculated actual fluid consumption values derived from changes in the fluid level measurements, historical discrepancy values representing differences between predicted fluid flow and actual fluid consumption, environmental operating conditions including temperature or pressure conditions within a fluid delivery system, pump runtime information, and tubing usage history associated with the peristaltic pump tubing. The machine-learning module may process the input data to generate output data including a trim coefficient configured to modify motor speed, a scaling factor configured to adjust a pump operating parameter, an adjusted motor speed command configured to compensate for degradation of peristaltic pump tubing, a calibrated pump control signal configured to maintain a target fluid delivery volume, predicted future discrepancy values associated with pump operation, or recommended maintenance indicators associated with pump component wear.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier may classify elements of training data to operating condition categories associated with pump performance characteristics, such as normal pump operation, early-stage tubing wear conditions, moderate tubing degradation conditions, advanced tubing degradation conditions, or abnormal pump performance conditions for which a subset of training data may be selected.

Still referring to FIG. 3, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P (B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{ma x} : {X}_{n e w} = \frac{X - {X}_{m i n}}{{X}_{m ax} - {X}_{m i n}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{m ax} - {X}_{m i n}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include motor revolutions per minute measurements, predicted fluid flow values derived from motor speed, fluid level measurements obtained from a fluid storage container, calculated actual fluid consumption values derived from changes in the fluid level measurements, historical discrepancy values representing differences between predicted fluid flow rate and actual fluid consumption, pump runtime data, environmental operating conditions, and tubing usage history as described above as inputs, trim coefficient values, scaling factors configured to modify motor speed, adjusted motor speed commands, calibrated pump control signals configured to maintain a target fluid delivery volume, or predicted discrepancy correction values as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332 may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

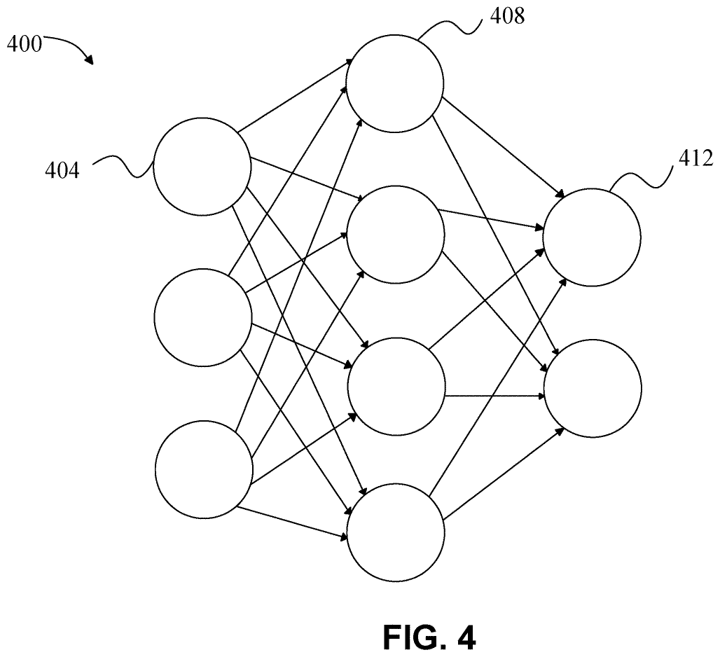

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

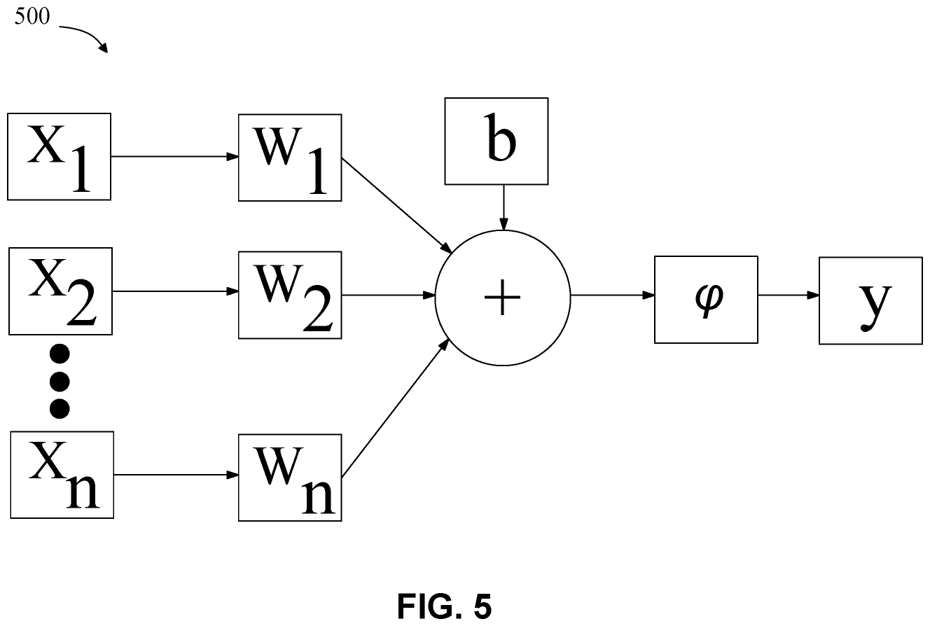

Referring now to FIG. 5, an exemplary embodiment of a node 500 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tan²(x), a rectified linear unit function such as f(x)=max(0, x), a “leaky” and/or “parametric” rectified linear unit function such as f(x)=max(ax, x), for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(2/\sqrt{π} (x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix}$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

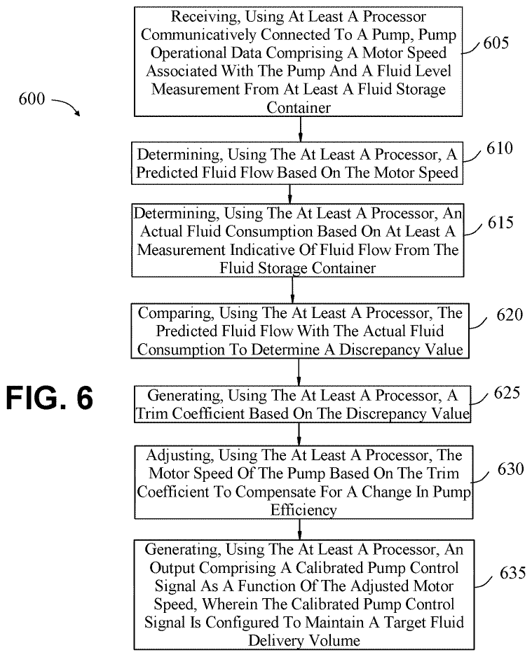

Referring now to FIG. 6, a flow diagram of an exemplary method 600 of generating an output is illustrated. At step 605, method 600 includes receiving, using at least a processor communicatively connected to a pump, pump operational data including a motor speed associated with the pump, wherein the pump is fluidly connected to at least a fluid storage container containing a fluid. In one or more embodiments, pump operational data may include a fluid level measurement from at least a fluid storage container. In an embodiment, receiving the pump operational data further may include receiving the motor speed from a motor controller communicatively connected to the pump, wherein the pump comprises a peristaltic pump tubing. In an embodiment, receiving the pump operational data further may include receiving the fluid level measurement from at least one level sensor associated with the fluid storage container. This may be implemented as described and with reference to FIGS. 1-5.

Still referring to FIG. 6, at step 610, method 600 includes determining, using the at least a processor, a predicted fluid flow rate of the fluid based on the motor speed. In an embodiment, determining the predicted fluid flow rate may include determining the predicted fluid flow rate as a function of a relationship between motor revolutions per minute and an expected volumetric displacement of the pump. This may be implemented as described and with reference to FIGS. 1-5.

Still referring to FIG. 6, at step 615, method 600 includes determining, using the at least a processor, an actual fluid consumption of the fluid based on at least a measurement indicative of a fluid flow of the fluid from the fluid storage container. In an embodiment, the at least a measurement indicative of fluid flow comprises a time-based fluid level measurement of the fluid storage container. In an embodiment, determining the actual fluid consumption may include determining the actual fluid consumption based on a change in the fluid level measurement over a time interval. This may be implemented as described and with reference to FIGS. 1-5.

Still referring to FIG. 6, at step 620, method 600 includes comparing, using the at least a processor, the predicted fluid flow rate with the actual fluid consumption to determine a discrepancy value. This may be implemented as described and with reference to FIGS. 1-5.

Still referring to FIG. 6, at step 625, method 600 includes generating, using the at least a processor, a trim coefficient based on the discrepancy value. In an embodiment, generating the trim coefficient further may include training a machine-learning model using trim training data, wherein the trim training data comprises historical motor speed data corresponding to historical fluid level measurements, and historical discrepancy values determined based on differences between predicted fluid flow rate derived from the historical motor speed data and actual fluid consumption derived from the historical fluid level measurements and retraining the machine-learning model using updated pump operational data and subsequently determined discrepancy values to generate the trim coefficient. In an embodiment, generating the trim coefficient may include determining a scaling factor configured to modify the motor speed of the pump. This may be implemented as described and with reference to FIGS. 1-5.

Still referring to FIG. 6, at step 630, method 600 includes adjusting, using the at least a processor, the motor speed of the pump based on the trim coefficient to compensate for a change in volumetric pump efficiency. In an embodiment, the change in volumetric pump efficiency comprises degradation of a peristaltic pump tubing associated with the pump. In an embodiment, adjusting the motor speed of the pump may include increasing the motor speed in response to the discrepancy value indicating reduced fluid delivery due to degradation of the peristaltic pump tubing. This may be implemented as described and with reference to FIGS. 1-5

Still referring to FIG. 6, at step 635, method 600 includes generating, using the at least a processor, an output comprising a calibrated pump control signal as a function of the adjusted motor speed, wherein the calibrated pump control signal is configured to maintain a target fluid delivery volume. In an embodiment, the memory further may include instructions configuring the at least a processor to periodically update the trim coefficient during operation of the pump. In an embodiment, the instructions further configure the at least a processor to transmit the calibrated pump control signal to a motor controller and control the pump using the motor controller based on the transmitted calibrated pump control signal. This may be implemented as described and with reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

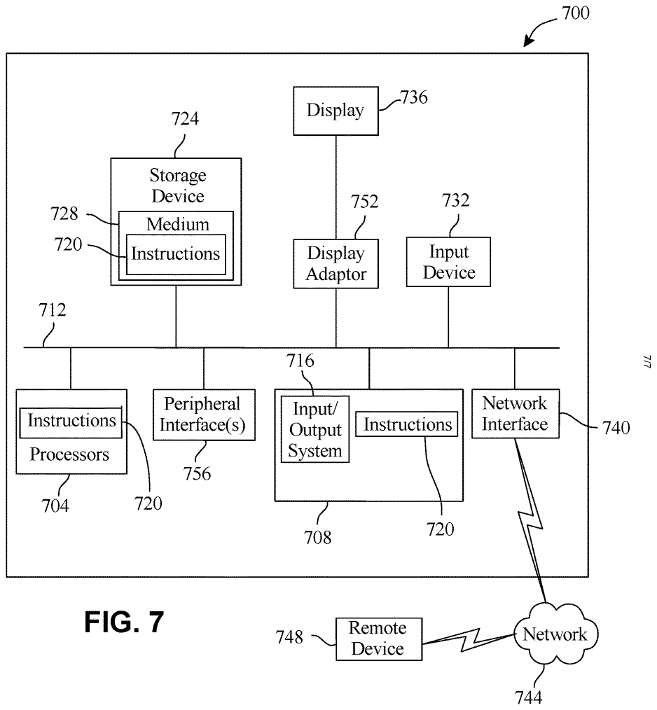

FIG. 7 shows a diagrammatic representation of one embodiment of computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display device 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for controlling pump operation, wherein the apparatus comprises:
a memory; and
at least a processor communicatively connected to the memory, wherein the memory contains instructions configuring the at least a processor to:
receive pump operational data comprising a motor speed associated with a pump, wherein the pump is fluidly connected to at least a fluid storage container containing a fluid;
determine a predicted fluid flow rate of the fluid from the at least a fluid container based on the motor speed;
determine an actual fluid consumption of the fluid based on at least a measurement indicative of a fluid flow of the fluid from the fluid storage container
compare the predicted fluid flow rate with the actual fluid consumption to determine a discrepancy value;
generate a trim coefficient based on the discrepancy value;
adjust the motor speed of the pump based on the trim coefficient to compensate for a change in volumetric pump efficiency; and
generate an output comprising a calibrated pump control signal as a function of the adjusted motor speed, wherein the calibrated pump control signal is configured to maintain a target fluid delivery volume.

2. The apparatus of claim 1, wherein receiving the pump operational data further comprises receiving the motor speed from a motor controller communicatively connected to the pump, wherein the pump comprises a peristaltic pump tubing.

3. The apparatus of claim 2, wherein the instructions further configure the at least a processor to:
transmit the calibrated pump control signal to a motor controller; and
control the pump using the motor controller based on the transmitted calibrated pump control signal.

4. The apparatus of claim 2, wherein the change in volumetric pump efficiency comprises degradation of the peristaltic pump tubing associated with the pump.

5. The apparatus of claim 1, wherein determining the actual fluid consumption based on the at least a measurement indicative of the fluid flow of the fluid comprises receiving a fluid level measurement of the fluid within the at least a storage container from at least one level sensor associated with the at least a fluid storage container.

6. The apparatus of claim 1, wherein determining the predicted fluid flow rate comprises determining the predicted fluid flow rate as a function of a relationship between motor revolutions per minute and an expected volumetric displacement of the pump.

7. The apparatus of claim 1, wherein determining the actual fluid consumption comprises determining the actual fluid consumption based on a change in a fluid level measurement of the at least a storage container over a time interval.

8. The apparatus of claim 1, wherein the at least a measurement indicative of fluid flow comprises a time-based fluid level measurement of the fluid storage container.

9. The apparatus of claim 1, wherein generating the trim coefficient comprises determining a scaling factor configured to modify the motor speed of the pump.

10. The apparatus of claim 1, wherein the memory further contains instructions configuring the at least a processor to periodically update the trim coefficient during operation of the pump.

11. A method of controlling pump operation, wherein the method comprises:
receiving, using at least a processor communicatively connected to a pump, pump operational data comprising a motor speed associated with the pump, wherein the pump is fluidly connected to at least a fluid storage container containing a fluid;
determining, using the at least a processor, a predicted fluid flow rate of the fluid based on the motor speed;
determining, using the at least a processor, an actual fluid consumption of the fluid based on at least a measurement indicative of a fluid flow of the fluid from the fluid storage container;
comparing, using the at least a processor, the predicted fluid flow rate with the actual fluid consumption to determine a discrepancy value;
generating, using the at least a processor, a trim coefficient based on the discrepancy value;
adjusting, using the at least a processor, the motor speed of the pump based on the trim coefficient to compensate for a change in volumetric pump efficiency; and
generating, using the at least a processor, an output comprising a calibrated pump control signal as a function of the adjusted motor speed, wherein the calibrated pump control signal is configured to maintain a target fluid delivery volume.

12. The method of claim 11, further comprising receiving, using the at least a processor, the motor speed from a motor controller communicatively connected to the pump, wherein the pump comprises a peristaltic pump tubing.

13. The method of claim 12, further comprising:
transmitting, using the at least a processor, the calibrated pump control signal to the motor controller; and
controlling, using the at least a processor, the pump using the motor controller based on the transmitted calibrated pump control signal.

14. The method of claim 12, wherein the change in volumetric pump efficiency comprises degradation of the peristaltic pump tubing associated with the pump.

15. The method of claim 11, wherein determining, using the at least a processor, the actual fluid consumption based on the at least a measurement indicative of the fluid flow of the fluid comprises receiving, using the at least a processor, a fluid level measurement of the fluid within the at least a storage container from at least one level sensor associated with the at least a fluid storage container.

16. The method of claim 11, further comprising determining, using the at least a processor, the predicted fluid flow rate comprises determining the predicted fluid flow rate as a function of a relationship between motor revolutions per minute and an expected volumetric displacement of the pump.

17. The method of claim 11, further comprising determining, using the at least a processor, the actual fluid consumption comprises determining the actual fluid consumption based on a change in a fluid level measurement of the at least a storage container over a time interval.

18. The method of claim 11, wherein the at least a measurement indicative of fluid flow comprises a time-based fluid level measurement of the fluid storage container.

19. The method of claim 11, further comprising determining, using the at least a processor, a scaling factor configured to modify the motor speed of the pump.

20. The method of claim 11, further comprising periodically updating, using the at least a processor, the trim coefficient during operation of the pump.
